(19) United States
(12) Patent Application Publication
(10) Pub. No.: US 2018/0267276 A1
(43) Pub. Date: Sep. 20, 2018

(54) Far-Infrared Lens System, Optical Imaging Device, And Digital Apparatus

(71) Applicant: KONICA MINOLTA, INC., Chiyoda-ku (JP)

(72) Inventor: Manami KUISEKO, Kita-ku, Kyoto-shi (JP)

(21) Appl. No.: 15/544,202

(22) PCT Filed: Jan. 28, 2016
(86) PCT No.: PCT/JP2016/052457

§ 371 Date: Jul. 17, 2017

(30) Foreign Application Priority Data
Jan. 29, 2015 (JP) 2015-015427

(51) Int. Cl. G02B 13/14; G02B 13/00; G02B 13/18; G02B 9/06

(52) U.S. Cl. CPC G02B 13/14; G02B 13/003; G02B 9/06; G02B 13/008; G02B 13/18

(57) ABSTRACT

A far-infrared lens system is used for far-infrared wavelengths, and configures two lenses comprising, in the order from an object side, a first positive lens and a second positive lens. A refractive ratio of a lens material configuring the greatest core thickness in each lens is greater than 2.0 and less than or equal to 3.9 at a wavelength of 10 μm. A conditional expression 2.50<f1/f<7.40 is satisfied, where f1 represents a focal distance of a first lens L1, and f represents a focal distance of an entire far-infrared lens system LN. The half field of view ω of the far-infrared lens system is greater than 30°.

### TECHNICAL FIELD

The present invention relates to a far-infrared lens system, an imaging optical device, and a digital appliance. More particularly, the present invention relates to, for example, a far-infrared lens system that is an imaging lens system used in the far-infrared region (a wavelength range from 8 to 12 μm), that performs satisfactory aberration correction with as few as two lens elements despite being so wide-angled as to have a half angle of view ω larger than 30° in particular, and that is applicable to inexpensive camera systems; an imaging optical device that captures, with a far-infrared sensor, a far-infrared image acquired through the far-infrared lens system; and a digital appliance having an image input function that incorporates the far-infrared lens system.

### BACKGROUND ART

With the spread of monitoring cameras, security cameras, etc., inexpensive compact far-infrared lens systems have been sought. Lens materials used in far-infrared lens systems are more expensive than common optical glasses, and thus the lower the lens volume is, the lower the cost is. From this perspective, Patent Documents 1 to 4 propose relatively wide-angle far-infrared lens systems composed of two lens elements.

### LIST OF CITATIONS

### Patent Literature

### Patent Document 1: United States Patent Application Publication No. 2013/0271852

### Patent Document 2: Japanese Patent Application Publication No. 2013-195795

### Patent Document 3: United States Patent Application Publication No. 2012/0229892

Patent Document 4: U.S. Pat. No. 6,292,293

### SUMMARY OF THE INVENTION

### Technical Problem

In the lens systems disclosed in Patent Documents 1 and 4 mentioned above, the focal length of the first lens element normalized with respect to the focal length of the entire system has a positive value. In the lens system disclosed in Patent Document 1, the focal length of the first lens element has a small positive value, indicating a relatively strong positive optical power (an optical power being a quantity defined as the reciprocal of a focal length). As a result, outward coma aberration occurs in the first lens element due to its positive optical power while aberration correction is not satisfactorily performed in the second lens element; this makes it impossible to obtain satisfactory performance with a construction with few lens elements. Also, the lens back is then too small. In the lens system disclosed in Patent Document 4, the focal length of the first lens element has a large positive value, indicating a weak positive optical power. When the optical power of the first lens element is too weak, in a wide-angle lens system, which requires a short focal length, the power burden on the second element is too heavy; this inconveniently results in large aberrations, leading to degraded performance chiefly due to off-axis inward coma aberration.

In the lens systems disclosed in Patent Documents 2 and 3 mentioned above, the focal length of the first lens element normalized with respect to the focal length of the enter system has a small negative value, indicating a strong negative optical power. When the negative optical power is too strong, it is stronger than the optical power with which the second lens element converges light, with the result that performance is rather degraded.

In the lens systems disclosed in Patent Documents 2 and 3 mentioned above, the back focus normalized with respect to the focal length is long. Moreover, the fact that, in a far-infrared lens system, the brightness of the system has an influence on resolution, results in a configuration that is bright, with an F-number equal to or lower than 2, and that shuts out as little of the off-axis beam as possible. In such a lens system, when the back focus is long and when the distance from the image surface to the second lens element is long, the F-number rays pass through the second lens element at higher positions relative to the optical axis; this inconveniently leads to an increased burden of spherical aberration correction on the second lens element. Moreover, on-axis and off-axis beams pass through at almost the same height, and this makes it difficult to effectively perform off-axis performance correction (correction of curvature of field, etc.). Thus, it is impossible to obtain satisfactory performance with a lens system having few lens elements.

In the lens system disclosed in Patent Document 1 mentioned above, as the first lens element, a lens element having a relatively low meniscusness is arranged with its concave surface pointing to the object side. The meniscusness is determined according to the paraxial radii of curvature of the front and rear surfaces of a lens element. Let the radius of curvature of the front surface be R1 and let the radius of curvature of the rear surface be R2, then the meniscusness is expressed by (R1+R2)/(R1−R2). The formula suggests that, with the radii of curvature considered in terms of signed values, the higher the absolute values are, the closer together the radii of curvature of the front and rear surfaces are, and thus the higher the meniscusness is. The one disclosed in Patent Document 1 is a positive lens element having low meniscusness and a relatively strong optical power, and thus the first lens element too produces spherical aberration and curvature of field due to its positive optical power. Aberrations that occur in the second lens element due to its positive optical power may be smaller, but since aberration correction is not actively performed in the first lens element, it is impossible to sufficiently reduce aberrations with few lens element; this tends to result in degraded performance particularly with wide-angle lens systems.

In the lens systems disclosed in Patent Documents 2 and 3 mentioned above, the first lens element is a negative lens element, and here if it has low meniscusness, it has a relatively strong negative optical power. Aberrations may be produced by the first lens element with its negative optical power so as to exert an effect of correcting the aberrations produced by the second lens element with its positive optical power, but the negative optical power is too strong; rays of light pass through the second lens element at higher positions relative to the optical axis, and still larger aberrations are produced, leading to rather degraded performance with wide-angle lens systems.

Against the background discussed above, an object of the present invention is to provide a high-performance, inexpensive far-infrared lens system that satisfactorily performs aberration correction with respect to on-axis and off-axis light beams with as few as two lens elements, and to provide an imaging optical device and a digital appliance incorporating such a far-infrared lens system.

### Means for Solving the Problem

To achieve the above object, according to a first aspect of the present invention, a far-infrared lens system for use in the far-infrared region is composed of two lens elements, which are, from the object side, a first lens element having a positive optical power and a second lens element having a positive optical power. Here, the refractive index of the lens material that constitutes the largest central thickness in each lens element is, at a wavelength of 10 μm, higher than 2.0 but equal to or lower than 3.9, conditional formula (1) below is fulfilled, and a half-angle of view is larger than 30°.

2.50<f1/f<7.40 (1)

where
f1 represents the focal length of the first lens element; and
f represents the focal length of the entire far-infrared lens system.

According to a second aspect of the present invention, in the above-described far-infrared lens system according to the first aspect, when dispersions ν at wavelengths from 8 to 12 μm are defined by formula (FD) below, a dispersion ν of the lens material that constitutes the largest central thickness in each of the first and second lens elements is higher than 100.

ν=(N10−1)/(N8−N12) (FD)

where
N10 represents the refractive index at a wavelength of 10 μm;
N8 represents the refractive index at a wavelength of 8 μm; and
N12 represents the refractive index at a wavelength of 12 μm.

According to a third aspect of the present invention, in the above-described far-infrared lens system according to the first or second aspect, conditional formula (2) below is fulfilled:

0.11<f2/f1<0.60 (2)

where
f1 represents the focal length of the first lens element; and
f2 represents the focal length of the second lens element.

According to a fourth aspect of the present invention, in the above-described far-infrared lens system according to any one of the first to third aspects, conditional formula (3) below is fulfilled:

−9.40<(R1+R2)/(R1−R2)<3.65 (3)

where
R1 represents the radius of curvature of the most object-side surface of the first lens element; and
R2 represents the radius of curvature of the most image-side surface of the first lens element.

According to a fifth aspect of the present invention, in the above-described far-infrared lens system according to any one of the first to fourth aspects, conditional formula (4) below is fulfilled:

0.34<D1/f<0.89 (4)

where
D1 represents the total on-axis central thickness from the most object-side surface to the most image-side surface of the first lens element; and
f represents the focal length of the entire far-infrared lens system.

According to a sixth aspect of the present invention, in the above-described far-infrared lens system according to any one of the first to fifth aspects, conditional formula (5) below is fulfilled:

0.2<LB/f<1.1 (5)

where
LB represents the air-equivalent length of a distance from a most image-side surface of the second lens element to an image surface; and
f represents the focal length of the entire far-infrared lens system.

According to a seventh aspect of the present invention, an imaging optical device includes the above-described far-infrared lens system according to any one of the first to sixth aspects, and a far-infrared sensor which converts a far-infrared optical image formed on an imaging surface thereof into an electrical signal. Here, the far-infrared lens system is arranged such that a far-infrared optical image of a subject is formed on the imaging surface of the far-infrared sensor.

According to an eighth aspect of the present invention, a digital appliance includes the above-described imaging optical device according to the seventh aspect so as to be additionally provided with at least one of functions of taking a still image of a subject and taking a moving image of a subject.

According to a ninth aspect of the present invention, a far-infrared camera system is provided with the above-described far-infrared lens system according to any one of the first to sixth aspects.

### Advantageous Effects of the Invention

According to the present invention, it is possible to actively perform aberration correction with respect to on-axis and off-axis beams even with as few as two lens element; owing to satisfactory aberration correction, it is possible to achieve higher performance and higher resolution, and thus to cope with inexpensive far-infrared sensors, which are manufactured today. Thus, it is possible to obtain an inexpensive but high-performance far-infrared lens system, and an imaging optical device provided with such a far-infrared lens system. By using a far-infrared lens system or an imaging optical device according to the present invention in a digital appliance such as a night vision device, a thermographic device, a mobile terminal, a camera system (for example, a digital camera, a monitoring camera, a security camera, and an vehicle-mounted camera), etc., it is possible to compactly add a high-performance far-infrared image input function to the digital appliance at low cost.

### BRIEF DESCRIPTION OF DRAWINGS

FIG. 1 is a lens construction diagram of a first embodiment (Example 1) of the present invention;

FIGS. 2A to 2C are aberration diagrams of Example 1;

FIG. 3 is a lens construction diagram of a second embodiment (Example 2) of the present invention;

FIGS. 4A to 4C are aberration diagrams of Example 2;

FIG. 5 is a lens construction diagram of a third embodiment (Example 3) of the present invention;

FIGS. 6A to 6C are aberration diagrams of Example 3;

FIG. 7 is a lens construction diagram of a fourth embodiment (Example 4) of the present invention;

FIGS. 8A to 8C are aberration diagrams of Example 4;

FIG. 9 is a lens construction diagram of a fifth embodiment (Example 5) of the present invention;

FIGS. 10A to 10C are aberration diagrams of Example 5;

FIG. 11 is a lens construction diagram of a sixth embodiment (Example 6) of the present invention;

FIGS. 12A to 12C are aberration diagrams of Example 6;

FIG. 13 is a lens construction diagram of a seventh embodiment (Example 7) of the present invention;

FIGS. 14A to 14C are aberration diagrams of Example 7;

FIG. 15 is a lens construction diagram of an eighth embodiment (Example 8) of the present invention;

FIGS. 16A to 16C are aberration diagrams of Example 8;

FIG. 17 is a lens construction diagram of a ninth embodiment (Example 9) of the present invention;

FIGS. 18A to 18C are aberration diagrams of Example 9;

FIG. 19 is a lens construction diagram of a tenth embodiment (Example 10) of the present invention;

FIGS. 20A to 20C are aberration diagrams of Example 10;

FIG. 21 is a lens construction diagram of an eleventh embodiment (Example 11) of the present invention;

FIGS. 22A to 22C are aberration diagrams of Example 11;

FIG. 23 is a lens construction diagram of a twelfth embodiment (Example 12) of the present invention;

FIGS. 24A to 24C are aberration diagrams of Example 12;

FIG. 25 is a lens construction diagram of a thirteenth embodiment (Example 13) of the present invention;

FIGS. 26A to 26C are aberration diagrams of Example 13;

FIG. 27 is a lens construction diagram of a fourteenth embodiment (Example 14) of the present invention;

FIGS. 28A to 28C are aberration diagrams of Example 14;

FIG. 29 is a lens construction diagram of a fifteenth embodiment (Example 15) of the present invention;

FIGS. 30A to 30C are aberration diagrams of Example 15;

FIG. 31 is a lens construction diagram of a sixteenth embodiment (Example 16) of the present invention;

FIGS. 32A to 32C are aberration diagrams of Example 16;

FIG. 33 is a lens construction diagram of a seventeenth embodiment (Example 17) of the present invention;

FIGS. 34A to 34C are aberration diagrams of Example 17; and

FIG. 35 is a schematic diagram showing an example of a configuration, in outline, of a digital appliance incorporating a far-infrared lens system.

### DESCRIPTION OF EMBODIMENTS

Hereinafter, a far-infrared lens system, an imaging optical device, a digital appliance, etc. according to the present invention will be described. A far-infrared lens system according to the present invention is characterized in that it is a lens system used in the far-infrared region; that it is composed of two lens elements, namely from the object side, a first lens element having a positive optical power and a second lens element having a positive optical power; that the refractive index of the lens material that constitutes the largest central thickness in each lens element is, at a wavelength of 10 μm, higher than 2.0 but equal to or lower than 3.9; that conditional formula (1) below is satisfied; and that the half-angle of view is larger than 30°.

2.50<f1/f<7.40 (1)

where
f1 represents the focal length of the first lens element; and
f represents the focal length of the entire far-infrared lens system.

The first and second lens elements having positive optical powers are each a single-piece lens element that functions as a single lens element. Thus, they are not limited to single lens elements made of a uniform optical material but may instead be those obtained by coating the surface of a lens core made of a uniform optical material with a thin coating layer of a material (for example, a resin material) other than that of the lens core. Examples of lens elements having a coating layer include compound lens elements such as hybrid aspherical lens elements. To make good use of the properties of a material (for example, silicon) that forms the lens core, it is necessary to make the coating layer thin, and thus cemented lens elements are unsuitable for the above-mentioned first and second lens elements. It is, however, possible to optically join a material which is thin enough not to spoil the optical properties of the main lens material. That is, the optically joined material needs to be one with such a thickness as to exhibit a sufficient transmittance in the far-infrared region, and is preferably one of which an integral structure with the main lens material functions as a single lens element. As will be described later, two lens elements in Example 1 and Examples 3 to 11 and the first lens element in Example 2 are single lens elements, and the second lens element in Example 2 and two lens elements in Examples 12 to 17 are compound lens elements.

The refractive index is the ratio of the speed of light in matter to that in vacuum, and is represented, in the visible region, by the refractive index for the d-line (587 nm). However, this value has no significance in the far-infrared region, and thus the refractive index for a wavelength of 10 μm is often used representatively. For example, the refractive indices, for a wavelength of 10 μm, of conventionally used far-infrared optical materials are 4.004 for Ge, 3.418 for Si, 2.200 for ZnS, 2.407 for ZnSe, etc.

The material that forms the above-mentioned lens core or single lens element is a lens material that constitutes the largest center thickness in each of the first and second lens elements. The first and second lens elements are characterized in that the refractive index of the above-mentioned lens core or single lens element is, at a wavelength of 10 μm, higher than 2.0 but equal to or lower than 3.9. That is, of far-infrared optical materials, those that have a refractive index higher than 2.0 but equal to or lower than 3.9 at a wavelength of 10 μm are used as the main lens material of the first and second lens elements.

As a far-infrared lens material, germanium (Ge) is well known which has a refractive index higher than 3.9 at a wavelength of 10 μm, and is used in many far-infrared optical systems. Although germanium is advantageous in aberration correction with its high refractive index, being a rare mineral, it incurs very high material cost; this hinders far-infrared cameras from being widespread. As a far-infrared lens material with a refractive index lower than 2.0, inorganic crystal materials such as sodium chloride (NaCl) and potassium bromide (KBr) are known. Although these are inexpensive materials, they are disadvantageous in aberration correction due to their extremely low refractive indices; this makes it difficult to build an imaging lens system with few lens elements.

Representative examples of far-infrared lens materials having a refractive index higher than 2.0 but equal to or lower than 3.9 at a wavelength of 10 μm include silicon (Si; with a refractive index of 3.4178). Silicon does not have a refractive index as high as germanium, but has a comparatively high refractive index among far-infrared lens materials, and thus silicon is sufficiently advantageous in aberration correction; this makes it possible to build an optical system that offers excellent performance with few lens elements. By use of a material having a refractive index larger than 2.0 at a wavelength of 10 μm, it is possible to make all the curvatures of a lens element gentle; this makes it possible, even with a lens system having a wide angle of view and a small focal length, to correct spherical aberration, curvature of field, on-axis and off-axis aberrations, etc. satisfactorily with as few as two lens elements. By use of a material having a refractive index equal to or lower than 3.9 at a wavelength of 10 μm, it is possible to manufacture a lens system with an inexpensive material that does not contain germanium, which is a rare material.

The first lens element is designed such that its focal length f1 satisfies conditional formula (1). With this construction, the focal length is comparatively large as compared with that of a conventional common wide-angle lens system composed of two positive lens elements. In wide-angle lens systems, the smaller the focal length is, the smaller the lens back is. Most inexpensive far-infrared sensors are of a non-cooling type which does not require cooling, and in such sensors, to increase the sensitivity, a space in front of the light-receiving surface is sealed with a window member with a vacuum secured between the window member and the light-receiving surface. The structure applies to sensors with few pixels and a small-size screen, and thus the smaller sensor a lens system is designed for, the larger lens back needs to be secured as compared with the focal length.

By setting, in a defined range, the focal length of the first lens element normalized as described above, it is possible to secure a sufficient back focus even for small sensors, and it is also possible to satisfactorily perform aberration correction in the first lens element, thereby achieving satisfactory performance with few lens elements. With f1/f above the lower limit of conditional formula (1), it is possible to secure a sufficient lens back even with a construction with two positive lens elements, and to cope with inexpensive sensors with a small-size screen. It is also possible to prevent distortion from increasing in the positive direction and to prevent outward coma aberration from occurring. With f1/f larger than the upper limit of conditional formula (1), the power load of a higher optical power needs to be distributed to the second lens element; this makes it difficult to sufficiently reduce spherical aberration. Moreover, large coma aberration may appear inward.

Far-infrared radiation is infrared radiation that typically falls in a wavelength range from 7 to 14 μm. The body temperature of humans and animals is radiated light having a wavelength from 8 to 12 μm, and most far-infrared optical systems are used at wavelengths from 8 to 12 μm. The far-infrared region in a wavelength range from 8 to 12 μm is a range in which the temperature of matter can be detected, and finds many applications such as temperature measurement, human detection in the dark, security, etc.

As yet, far-infrared cameras are not widespread, because lens materials that transmit far-infrared are materials which contain an expensive rare material or materials which are difficult to process, and it is expensive to build a lens system that include a plurality of lens elements or more using such materials. Now that the technology of manufacturing far-infrared sensors has advanced, and that inexpensive thermopiles, non-cooling micro-bolometer, etc. are manufactured, inexpensive lens systems suitable for these devices are sought. A far-infrared lens system according to the present invention is composed of two lens elements, namely from the object side, a first lens element and a second lens element, and thus as a lens system composed of few lens elements. This makes it possible to provide an inexpensive lens system by reducing its processing cost.

Most conventional far-infrared sensors are expensive ones that can display temperature resolution precisely. With such a sensor, it is necessary to cool around the sensor with refrigerant such as liquid nitrogen to permit the sensor to sufficiently exert temperature resolution. This requires a space for cooling, and thus wide-angle lens systems which tend to have a relatively small lens back have hardly been manufactured. However, there are needs for wider fields of view, and in recent years, it is possible to manufacture, at low cost, non-cooling sensors such as micro-bolometers, which do not require cooling. This makes it possible to obtain wide-angle far-infrared lens systems whose half-angle of view ω is larger than 30°. A description will be given below of preferable condition settings, etc. to simultaneously obtain a wide angle of view and high performance with as few as two lens elements.

As to the focal length of the first lens element, it is preferable that conditional formula (1a) below be fulfilled, and it is further preferable that conditional formula (1b) be fulfilled.

2.50<f1/f<6.76 (1a)

3.73<f1/f<6.01 (1b)

Conditional formulae (1a) and (1b) define further preferable conditional ranges within the conditional range defined by conditional formula (1) from the above-mentioned viewpoints. Accordingly, preferably fulfilling conditional formula (1a), and further preferably fulfilling conditional formula (1b), helps enhance the above-mentioned effects.

When dispersions ν at wavelengths from 8 to 12 μm are defined by formula (FD) below, it is preferable that a dispersion ν of the lens material that constitutes the largest central thickness in each of the first and second lens elements be higher than 100.

ν=(N10−1)/(N8−N12) (FD)

where
N10 represents the refractive index at a wavelength of 10 μm;
N8 represents the refractive index at a wavelength of 8 μm; and
N12 represents the refractive index at a wavelength of 12 μm.

As a value that represents the property of dispersion, with respect to visible light, an Abbe number vd for the d-line is used. The Abbe number is expressed by vd=(Nd−1)/(Nf−Nc) (where Nd represents the refractive index for the d-line; Nf represents the refractive index for the F-line; and Nc represents the refractive index for the C-line). However, this value has no significance in the far-infrared region, and thus in the above-mentioned far-infrared lens systems, as a value that represents the property of dispersion, the value ν expressed by formula (FD), ν=(N10−1)/(N8−N12), is used. The higher the value ν is, the smaller the color-related difference in refractive index is, and thus the smaller the dispersion is. For example, the dispersions of conventionally used far-infrared optical materials are 750 or higher for Ge, 1860 for Si, 23 for ZnS (used for achromatization), 57 for ZnSe (used for achromatization), etc.

As described above, the lens material of the largest central thickness in each lens element has a dispersion value ν preferably higher than 100. One representative of such materials is Si, in which approximately ν=1860 as mentioned above. When such a low dispersion material is used, with far-infrared lens systems in which chromatic aberration needs to be corrected in a wavelength range from 8 to 12 μm or in a wider wavelength range from 7 to 12 μm depending on use, it is possible to make a design which is greatly advantageous in terms of chromatic aberration. Even for uses which require a lens element with high performance, it is possible to obtain a lens system with satisfactory performance with as few as two lens elements without performing special chromatic aberration correction as with a diffraction grating or the like, and thus to reduce the cost of the lens unit. Moreover, Si is a material less expensive than Ge, and this helps achieve further cost reduction.

Constructions with a high dispersion material having a dispersion ν lower than 100 may lead to insufficient chromatic aberration correction. Even when the aberration at a wavelength 10 μm is reduced by use of many aspherical surfaces, the spot diameter becomes several times to several tens of times larger than the pixel pitch, with the result that the far-infrared image that can be acquired is blurry; this makes it difficult to obtain satisfactory resolution.

It is preferable that conditional formula (2) below be fulfilled.

0.11<f2/f1<0.60 (2)

where
f1 represents the focal length of the first lens element; and
f2 represents the focal length of the second lens element.

Although, as described above, the range of the focal length of the first lens element is defined by conditional formula (1) so that a sufficient lens back can be secured even with inexpensive far-infrared sensors with a small-size screen, with wide-angle lens systems, it is difficult to obtain a practical optical system with satisfactory performance with no consideration given simultaneously to the ratio of the focal length of the first lens element to that of the second lens element. By fulfilling conditional formula (2), which defines the focal length ratio between the first and second lens elements, it is possible, even with wide-angle lens systems, to appropriately distribute the burden of aberration correction between the lens elements, and thus to obtain a lens system with satisfactory performance with as few as two lens elements.

Above the upper limit of conditional formula (2), when the focal length of the second lens element is large relative to that of the first lens element, to design a wide-angle lens system requires the first and second lens elements to be put close to each other; this makes it impossible to obtain a sufficient interval between the first and second lens elements to place a lens barrel component or an aperture stop, making it difficult to build a lens system. Moreover, a light beam passes through the first and second lens elements at largely the same height, and thus when on-axis performance such as with respect to spherical aberration is secured, it is difficult to satisfactorily correct curvature of field. By contrast, below the lower limit of conditional formula (2), when the focal length of the second lens element is small relative to that of the first lens element, the total length of the lens system is large; in addition the second lens element produces large spherical aberration in on-axis light beams, and refracts off-axis light beams so sharply inward as to produce coma aberration, making it difficult to obtain satisfactory optical performance.

It is preferable that conditional formula (2a) below be fulfilled, and it is further preferable that conditional formula (2b) be fulfilled.

0.12<f2/f1<0.40 (2a)

0.12<f2/f1<0.25 (2b)

Conditional formulae (2a) and (2b) define further preferable conditional ranges within the conditional range defined by conditional formula (2) from the above-mentioned viewpoints. Accordingly, preferably fulfilling conditional formula (2a) and further preferably fulfilling conditional formula (2b) helps enhance the above-mentioned effects.

It is preferable that conditional formula (3) below be fulfilled.

−9.40<(R1+R2)/(R1−R2)<3.65 (3)

where
R1 represents the radius of curvature of the most object-side surface of the first lens element; and
R2 represents the radius of curvature of the most image-side surface of the first lens element.

In wide-angle lens systems, the angles at which rays of light are incident on the first lens element are large, and thus the shape of the first lens element has a great influence on performance (R1+R2)/(R1−R2) in conditional formula (3) is referred to as “shaping factor” that represents the shape of a single lens element, and expresses the relationship between the radius of curvature R1 of the lens front surface (the most object-side surface) and the radius of curvature R2 of the lens rear surface (the most image-side surface). Whether the sign is positive or negative depends on the direction in which a lens surface points. When the radii of curvature of both surfaces including their signs are close to each other, the lens element exhibits higher meniscusness with a higher absolute value of the shaping factor; conversely, when the radii of curvature of both surfaces including their signs are distant from each other, the lens element exhibits lower meniscusness with a lower absolute value of the shaping factor. The radius of curvature R1 takes a positive value, indicating convexity to the object side, and the first lens element has a positive optical power; thus a greater negative value indicates higher meniscusness.

By setting the shaping factor of the first lens element within the defined range so as to fulfill conditional formula (3) and making it a positive lens element with medium to slightly high meniscusness, it is possible, in the first lens element, to chiefly correct spherical aberration, curvature of field, etc. and to cancel aberrations produced in the second lens element due to the positive optical power; this helps achieve improved performance With the shaping factor larger than the upper limit of conditional formula (3), the positive lens element has extremely low meniscusness, and off-axis rays are refracted at the front and rear of the first lent element so greatly as to produce coma aberration outward; this leads to degraded performance With the shaping factor smaller than the lower limit of conditional formula (3), the positive lens element has high meniscusness, and off-axis rays pass through the object-side surface of the first lens element at higher positions, resulting in increased curvature of field; this leads to degraded performance.

It is preferable that conditional formula (4) below be fulfilled.

0.34<D1/f<0.89 (4)

where
D1 represents the total on-axis central thickness from the most object-side surface to the most image-side surface of the first lens element; and
f represents the focal length of the entire far-infrared lens system.
   Let the i-th axial surface to surface distance from the object side be di, then when the first lens element is a single lens element, D1=d1 (the on-axis central thickness of the first lens element), and when the first lens element is a compound lens element, D1=d1+d2+d3 . . . (the total on-axis central thickness of the first lens element).

In wide-angle lens systems, the thickness of the first lens element, on which off-axis light beams are incident at large angles, has a great influence on performance, and thus in a far-infrared lens system according to the present invention, the total central thickness of the first lens element normalized with respect to the focal length of the entire system is set preferably within a predetermined range, and the range is defined by conditional formula (4) above. With the central thickness of the first lens element smaller than the lower limit of conditional formula (4), an off-axis light beam passes through the most object-side surface and the most image-side surface of the first lens element at largely the same height, through parts with similar curvatures, and thus curvature of field, etc. produced by the first lens element reach the second lens element without being satisfactorily corrected; this makes it impossible to eventually achieve satisfactory aberration correction, and thus makes it difficult to obtain satisfactory performance with as few as two lens elements. With the total central thickness of the first lens element larger than the upper limit of conditional formula (4), the distance from the most object-side surface to an aperture stop is large, and an off-axis light beam passes through the first lens element at a position so high as to produce outward coma aberration; this makes it difficult to obtain a lens system with satisfactory performance with as few as two lens elements.

It is preferable that conditional formula (5) below be fulfilled.

0.2<LB/f<1.1 (5)

where
LB represents the air-equivalent length of the distance from the most image-side surface of the second lens element to the image surface; and
f represents the focal length of the entire far-infrared lens system.

With consideration given to providing wide-angle lens systems that are applicable to inexpensive sensors with a small-size light-receiving surface, as described above, even with small-size sensors, the configuration of structural components such as a cover glass etc. is substantially similar, and thus small sensors require a large lens back relative to the screen size. When the lens back (back focus) normalized with respect to the focal length of the entire system is set within the defined range so as to fulfill conditional formula (5), the distance from the image surface (sensor surface) to the second lens is not too large; thus F-number rays pass through the second lens element at positions low enough to suppress spherical aberration, and simultaneously it is possible to effectively correct curvature of field in off-axis light beams. It is also possible to secure a sufficient space to insert a far-infrared sensor cover glass in it.

With the lens back smaller than the lower limit of conditional formula (5), even with a minimized number of optical members, it is difficult to secure a space to place a cover glass, etc. present in front of the sensor's light-receiving surface; this makes it difficult to build an imaging lens system. Here, a space around the sensor's light-receiving surface cannot be sealed in vacuum; this may inconveniently cause the heat of the sensor itself to appear in an image as noise, with the result that a clear image may not be acquired. With the lens back larger than the upper limit of conditional formula (5), the lens total length is large, and off-axis light beams pass through the lens element at higher positions; this makes it difficult to satisfactorily correct off-axis coma aberration and field of curvature. As a result, it is difficult to build a satisfactory lens system with as few as two lens elements.

A far-infrared lens system according to the present invention is suitable as an imaging lens system for far-infrared camera systems. As described above, one of the reasons that far-infrared cameras are not widespread is that they require expensive lens materials and lens processing. With a simple lens system composed of two lens elements as described above, it is possible to reduce lens processing cost, etc., and thus to obtain an inexpensive lens system.

In a far-infrared lens system according to the present invention, a diffraction grating may be provided on at least one of the lens surfaces of the first and second lens elements. By providing a diffraction grating, it is possible to satisfactorily correct longitudinal chromatic aberration, etc. As the sectional shape of the diffraction grating, other than a binary shape, a step (stair)-like shape or a kinoform shape may be used.

Although in a far-infrared lens system according to the present invention, as a cover glass provided in a far-infrared sensor, one that is made of silicon is assumed to be used, instead, one that is made of germanium may be used. When the second lens element and the sensor cover glass are integrated together, for the second lens element, the same material as the cover glass may be used or a material different from the cover glass may be used, and the second lens element may be given a flat surface on the image surface side thereof and arranged close to the cover glass.

By adopting, singly or in combination as necessary, the different constructions for which conditions are set as described above, it is possible to actively perform aberration correction with respect to on-axis and off-axis light beams with as few as two lens elements. Thus, owing to satisfactory aberration correction, it is possible to achieve wider angles while achieving higher performance and higher resolution with as few as two lens elements, and thus to cope with inexpensive far-infrared sensors, which are manufactured today. Thus, it is possible to obtain an inexpensive but high-performance far-infrared lens system, and an imaging optical device provided with such a far-infrared lens system.

By using such a far-infrared lens system or imaging optical device in a digital appliance such as a night vision device, a thermographic device, a mobile terminal, a camera system (for example, a digital camera, a monitoring camera, a security camera, and an vehicle-mounted camera), etc., it is possible to compactly add a high-performance far-infrared image input function to the digital appliance at low cost; this contributes to further compactness, higher performance, higher functionality, etc. in the digital appliance. As described above, one of the reasons that far-infrared cameras are not widespread is that they require expensive lens materials and lens processing. By using a simple lens system composed of two lens elements as a far-infrared lens system, it is possible to reduce lens processing cost, etc. and thus to obtain an inexpensive camera system.

A far-infrared lens system according to the present invention is suitable for use as an imaging optical system for digital appliances (for example, mobile terminals and driving recorders) having a far-infrared image input function. By combining the far-infrared lens system with a far-infrared sensor for imaging or the like, it is possible to build a far-infrared imaging optical device that optically receives a far-infrared image of a subject and outputs it as an electrical signal. An imaging optical device is an optical device that constitutes a main component of a camera used to take a still image and a moving image of a subject, and is, for example, composed of, from the object side (that is, the subject side), a far-infrared lens system that forms a far-infrared optical image of an object, and a far-infrared sensor (imaging device) that converts the far-infrared optical image formed by the far-infrared lens system into an electrical signal. By arranging a far-infrared lens system having a distinctive construction as described above such that a far-infrared optical image of a subject is formed on the light-receiving surface (that is, the imaging surface) of the far-infrared sensor, it is possible to obtain a small, inexpensive, high-performance imaging optical device, and a digital appliance provided with such an imaging optical device.

Examples of digital appliances having a far-infrared image input function include camera systems such as infrared cameras, monitoring cameras, security cameras, vehicle-mounted cameras, cameras for airplanes, digital cameras, video cameras, and cameras for videophones, and also include digital appliances obtained by incorporating a camera function in, or externally fitting it to personal computers, night vision devices, thermographic devices, portable digital appliances (for example, compact, portable information devices and terminals such as cellular phones, smart phones (high functional cellular phones), tablet terminals, and mobile computers), peripheral devices therefor (such as scanners, printers, and mice), other digital appliances (such as driving recorders and defense devices), etc. As will be understood from these examples, it is possible not only, by using far-infrared imaging optical devices, to build infrared camera systems, but also, by incorporating such imaging optical devices in various appliances, to add thereto a far-infrared camera function, a night vision function, a temperature measurement function, etc. For example, it is possible to build digital appliances having a far-infrared image input function, such as smartphones with a far-infrared camera.

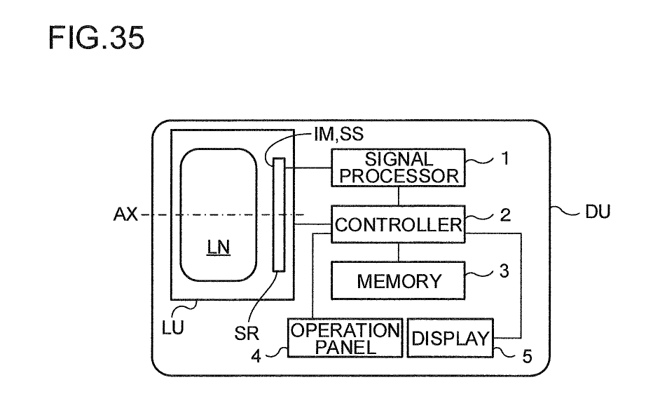

FIG. 35 is a schematic sectional view showing an example of an outline configuration of a digital appliance DU as one example of a digital appliance having a far-infrared image input function. An imaging optical device LU incorporated in the digital appliance DU shown in FIG. 35 includes, from the object side (that is, the subject side), a far-infrared lens system LN (with an optical axis AX) which forms a far-infrared optical image (image surface) IM of an object, and a far-infrared sensor (imaging device) SR which converts an optical image IM formed on the light-receiving surface (imaging surface) SS by the far-infrared lens system LN into an electrical signal. On the image surface IM side of the far-infrared lens system LN, a cover glass of the far-infrared sensor SR, an optical filter arranged as necessary, etc. are present as a plane-parallel plate (unillustrated). When the digital appliance DU having an image input function is built with this imaging optical device LU, the imaging optical device LU is typically arranged inside the body of the digital appliance DU; on the other hand, to obtain a camera function, it is possible to adopt configurations that suit the needs. For example, an imaging optical device LU integrated into a unit can be configured to be mountable on and dismountable from or be rotatable on the body of the digital appliance DU.

The far-infrared lens system LN is a single-focus lens system composed of two lens elements, namely in order from the object side, a first lens element and a second lens element, and is configured, as described above, to form an optical image IM with far-infrared rays on the light-receiving surface SS of the far-infrared rays sensor SR. Used as the far-infrared sensor SR is, for example, a far-infrared image sensor (such as a thermosensor) which has a plurality of pixels (for example, several thousand to several hundred thousand pixels) and which is used at wavelengths from approximately 8 to 12 μm. The far-infrared lens system LN is provided such that an optical image IM of a subject is formed on the light-receiving surface SS which is a photoelectric conversion portion of the far-infrared sensor SR, and thus an optical image IM formed by the far-infrared lens system LN is converted into an electrical signal by the far-infrared sensor SR.

Specific examples of far-infrared sensors SR include pyroelectric sensors, micro-bolometers, thermopiles, etc. A pyroelectric sensor exploits the pyroelectric effect by which ceramic containing lead zirconate titanate or the like is electrically polarized spontaneously in response to change in temperature; it typically has a single light-receiving surface and makes an inexpensive temperature sensor. A micro-bolometer is a temperature sensor that has a light-receiving surface on which a heat-sensitive material such as amorphous silicon or vanadium oxide is arrayed two-dimensionally by microfabrication technology and that detects change in resistance value caused by rise in temperature. Common micro-bolometers which are used today have, for example, 80×80, 320×240, or 640×480 pixels. While most of them require cooling around the sensor with liquid nitrogen or the like to sufficiently exert temperature resolution, by contrast, in recent years, with advances in manufacturing technology, micro-bolometers, which have a sufficient temperature detection capability without cooling, are manufactured. A thermopile is a temperature sensor that has, as a sensor surface, thermocouples, which can convert heat into electrical energy, connected in series or in parallel, and is the second most inexpensive following the pyroelectric sensor.

The digital appliance DU includes, in addition to the imaging optical device LU, a signal processor 1, a controller 2, a memory 3, an operation panel 4, a display 5, etc. The signal generated by the far-infrared sensor SR is subjected to predetermined digital image processing, image compression processing, etc. as necessary in the signal processor 1, and is recorded as a digital video signal in the memory 3 (such as a semiconductor memory or an optical disk) or, in some cases, transferred to other devices via a cable or after being converted into an infrared signal or the like (for example, a communication function of a cellular phone). The controller 2 comprises a micro-computer, and performs, in a concentrated fashion, control of functions such as image taking functions (such as a still image taking function and a moving image taking function) and an image playback function and control of a lens movement mechanism for focusing, and so forth. For example, the controller 2 controls the imaging optical device LU so as to take at least either a still image or a moving image of a subject. The display 5 is a portion which includes a display such as a liquid crystal monitor, and displays an image by use of an image signal converted by the far-infrared sensor SR or image information recorded in the memory 3. The operation device 4 is a portion which includes operation members such as an operation button (for example, a release button) and an operation dial (for example, an image taking mode dial), and transmits information entered through operation by an operator to the controller 2.

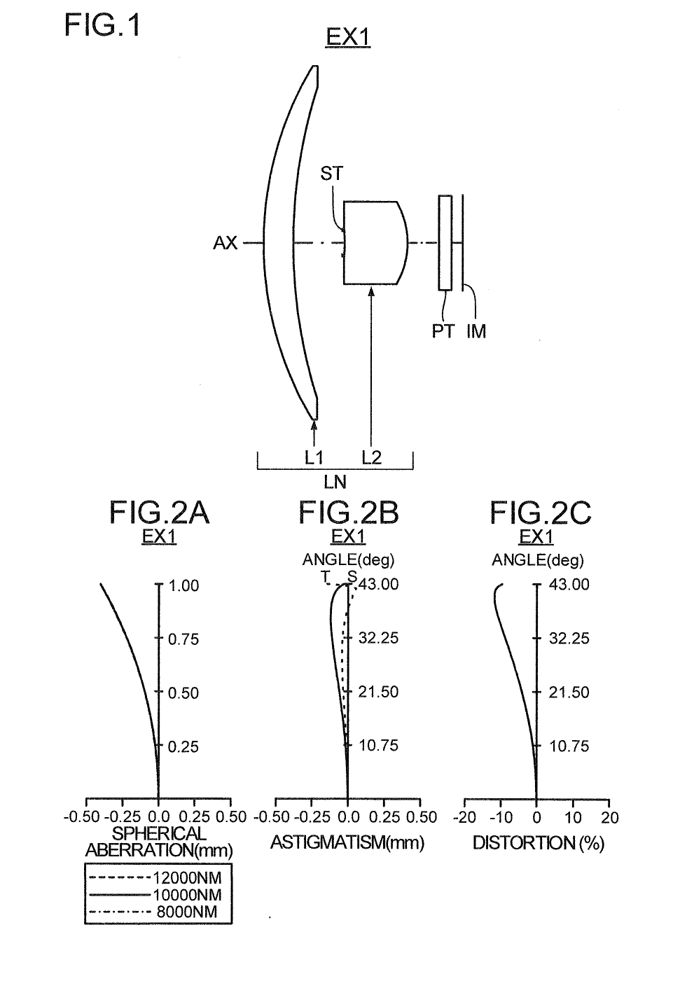

FIGS. 1, 3, 5, 7, 9, 11, 13, 15, 17, 19, 21, 23, 25, 27, 29, 31 and 33 are optical sectional views of the far-infrared lens system LN in an infinite focus state according to first to seventeenth embodiments respectively. In the first to seventeenth embodiments, the far-infrared lens system LN is composed of, from the object side, a first lens element L1 having a positive optical power and a second lens element L2 having a positive optical power. In the first and third to eleventh embodiments, the first lens element L1 and the second lens element L2 are each a single lens element. In the second embodiment, the first lens element L1 is a single lens element and the second lens element L2 is a compound lens element. In the twelfth to seventeenth embodiments, the first lens element L1 and the second lens element L2 are each a compound lens element. A compound lens element is formed by covering an entire lens core made of an inorganic material (up to the edge thereof) with a relatively thin coating layer made of a resin material. The coating layer that lies outside the effective region (the range from the optical axis AX to the effective diameter position) has no influence on optical performance, and thus in lens construction diagrams, the coating layer outside the effective region is omitted from illustration.

In the first, third, fourth, sixth to thirteenth, fifteenth, and sixteenth embodiments, on the image surface IM side of the far-infrared lens system LN, there is arranged a plane-parallel plate PT corresponding to a protective cover glass of the far-infrared sensor SR. In the second, fifth, fourteenth, and seventeenth embodiments, the second lens element L2 and the protective cover glass of the far-infrared sensor SR are integrated together.

### EXAMPLES

Now, the construction, etc. of far-infrared lens systems embodying the present invention will be described more specifically with reference to the construction data, etc. of examples. Examples 1 to 17 (EX 1 to 17) presented below are numerical examples corresponding to the above-described first to seventeenth embodiments respectively. The lens construction diagrams (FIGS. 1, 3, 5, 7, 9, 11, 13, 15, 17, 19, 21, 23, 25, 27, 29, 31 and 33) showing the first to seventeenth embodiments show the optical constructions, such as lens sectional shapes and lens arrangements, of the corresponding ones of Examples 1 to 17 respectively.

In the construction data of each example, listed as surface data are, in order starting with the leftmost column, surface number i (where OB represents the object surface, ST represents the aperture stop surface, and IM represents the image surface), paraxial radius of curvature r (mm), axial surface-to-surface distance d (mm), refractive index N10 at a design wavelength λ0 of 10 μm, and dispersion ν at a wavelength from 8 to 12 μm (a blank representing air).

A surface of which the surface number i is marked with an asterisk “*” is an aspherical surface, of which the surface shape is defined by formula (AS) below by use of a local rectangular coordinate system (x, y, z) having its origin at the vertex of the surface. Listed as aspherical surface data are aspherical surface coefficients, etc. In the aspherical surface data of each example, the coefficient of a term that does not appear is equal to zero, and for all the data, “E−n” stands for “10⁻ⁿ”.

z=(c·h²)/[1+√{1−(1+K)·c²·h²}]+Σ(Aj·h^{j}) (AS)

where
h represents the height in the direction perpendicular to the z-axis (optical axis AX) (h²=x²+y²);
z represents the amount of sag in the optical axis AX direction at the height h (relative to the surface vertex);
c represents the curvature at the surface vertex (the reciprocal of the paraxial radius of curvature r);
K represents the conic constant; and
Aj represents the aspherical surface coefficient of order j (where Σ represents the sum for j from order 4 to order ∞).

Listed below as refractive index and dispersion data of optical materials which form the lens elements, etc. are the refractive index N10 at a wavelength of 10 μm and the dispersion ν=(N10−1)/(N8−N12) at a wavelength from 8 to 12 μm. The plane-parallel plate PT preceding the image surface IM is a protective silicon plate (cover glass) of the far-infrared sensor SR.

### Silicon (Si) N10=3.4178, ν=1860

### Polyethylene N10=1.5226, ν=15.10

### Fluororesin N10=1.6700, ν=22.33

Listed as miscellaneous data (spec) are design wavelength λ0 (nm), focal length f (mm) of the entire system, F-number (FNO), total length TL (the distance from the foremost lens surface to the image surface IM, mm), and half angle of view (ω, °). Table 1 lists values corresponding to the conditional formulae in the examples and data related thereto.

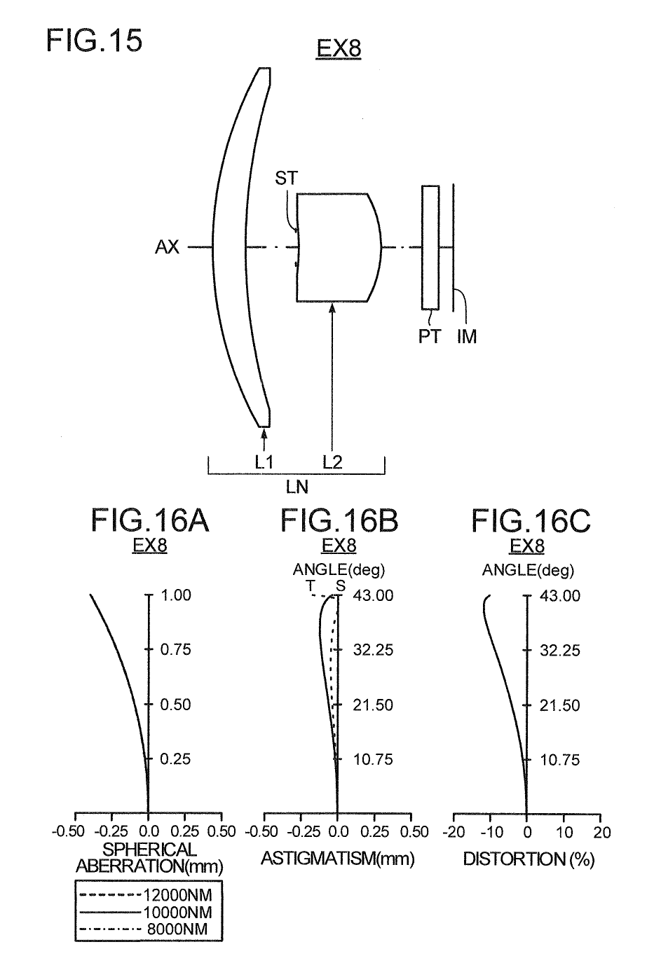

FIGS. 2A to 2C, 4A to 4C, 6A to 6C, 8A to 8C, 10A to 10C, 12A to 12C, 14A to 14C, 16A to 16C, 18A to 18C, 20A to 20C, 22A to 22C, 24A to 24C, 26A to 26C, 28A to 28C, 30A to 30C, 32A to 32C, and 34A to 34C are aberration diagrams corresponding to Examples 1 to 17 (EX1 to 17) respectively. FIGS. 2A, 4A, 6A, 8A, 10A, 12A, 14A, 16A, 18A, 20A, 22A, 24A, 26A, 28A, 30A, 32A, and 34A are spherical aberration diagrams, FIGS. 2B, 4B, 6B, 8B, 10B, 12B, 14B, 16B, 18B, 20B, 22B, 24B, 26B, 28B, 30B, 32B, and 34B are astigmatism diagrams, and FIGS. 2C, 4C, 6C, 8C, 10C, 12C, 14C, 16C, 18C, 20C, 22C, 24C, 26C, 28C, 30C, 32C, and 34C are distortion diagrams. The far-infrared sensor SR for which the lens systems are designed differs from one example, and thus the scale of the amount of aberration is adjusted according to the performance of the lens systems (the pitch for a sensor such as a micro-bolometer is, for example, 25 μm, 17 μm, or 12 μm, and the pitch for the sensor of a thermopile is, for example, 32 μm).

In spherical aberration diagrams with the suffix “A,” a solid line represents the amount of spherical aberration at a design wavelength (evaluation wavelength) of 10000 nm, a dash-dot line represents the amount of spherical aberration at a wavelength of 8000 nm, and a broken line represents the amount of spherical aberration at a wavelength of 12000 nm, all in terms of deviations (mm) from the paraxial image surface in the optical axis AX direction, the vertical axis representing the height of incidence at the pupil as normalized with respect to the maximum height of incidence (hence, the relative height at the pupil). In astigmatism diagrams with the suffix “B,” a broken line T represents the tangential image surface at a design wavelength of 10000 nm, and a solid line S represents the sagittal image surface at a design wavelength of 10000 nm, both in terms of deviations (mm) from the paraxial image surface in the optical axis AX direction, the vertical axis representing the half-angle of view ω (ANGLE, °). In distortion diagrams with the suffix “C,” the horizontal axis represents the distortion (%) at a design wavelength of 10000 nm, and the vertical axis represents the half-angle of view ω (ANGLE, °). The maximum value of the half-angle of view ω corresponds to the maximum image height Y′ on the image surface IM (one-half of the diagonal length of the light-receiving surface SS of the far-infrared sensor SR).

In Example 1 (EX1), the far-infrared lens system LN (FIG. 1) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a positive meniscus lens element convex to the image side. The plane-parallel plate PT constituting the sixth and seventh surfaces is a protective cover glass provided in a far-infrared sensor SR.

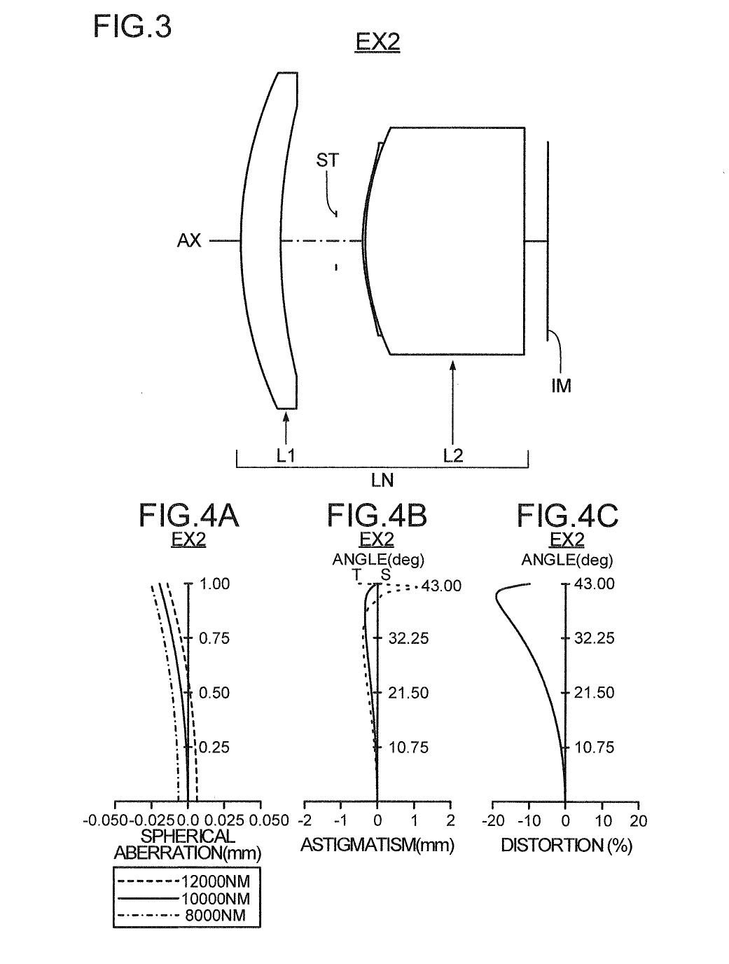

In Example 2 (EX2), the far-infrared lens system LN (FIG. 3) is composed of, from the object side, a first lens element L1 having a positive optical power, an aperture stop ST, and a second lens element L2 having a positive optical power and having a coating layer on the object-side surface. Considered in terms of paraxial surface shapes, the first lens element L1 is a positive meniscus lens element convex to the object side, and the second lens element L2 is a positive meniscus lens element convex to the object side. The most object-side surface of the second lens element L2 is an aspherical surface. The second lens element L2 constituting the fourth to sixth surfaces is integrated with a cover glass for a far-infrared sensor SR.

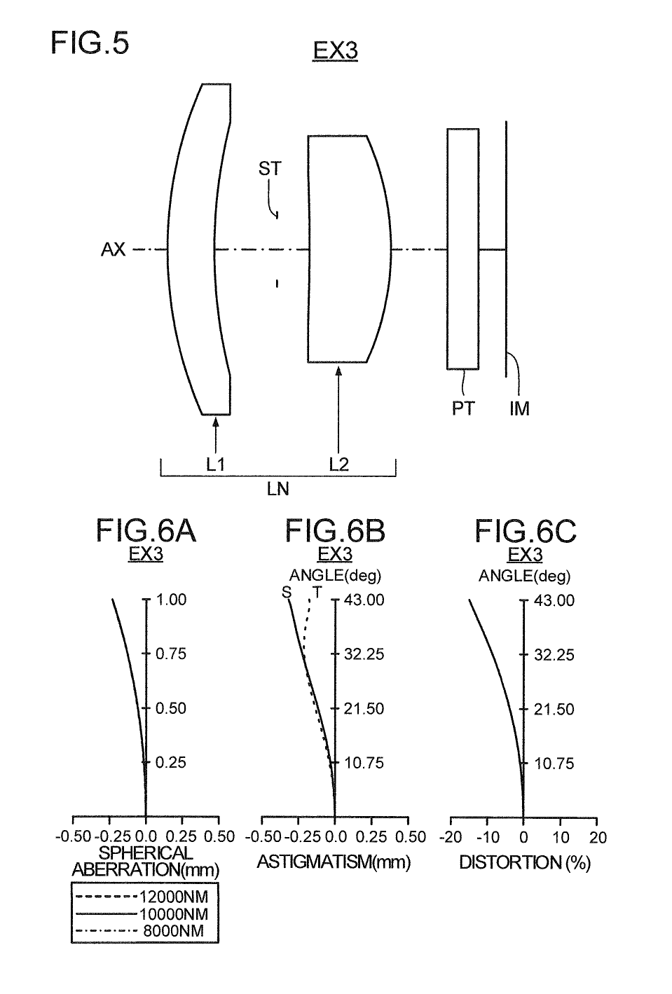

In Example 3 (EX3), the far-infrared lens system LN (FIG. 5) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a positive meniscus lens element convex to the image side. The plane-parallel plate PT constituting the sixth and seventh surfaces is a protective cover glass provided in a far-infrared sensor SR.

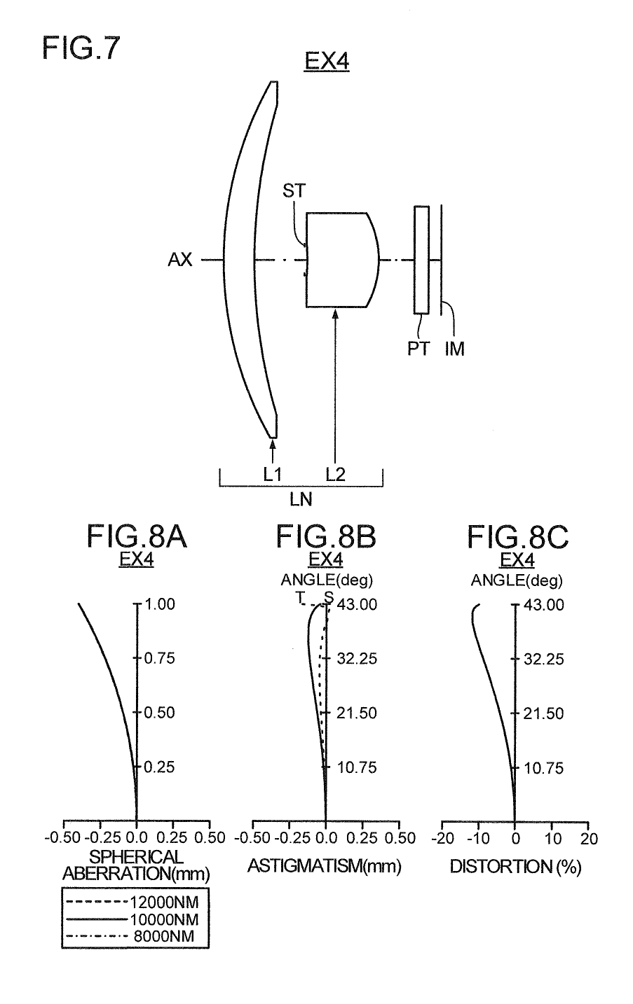

In Example 4 (EX4), the far-infrared lens system LN (FIG. 7) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a positive meniscus lens element convex to the image side. The plane-parallel plate PT constituting the sixth and seventh surfaces is a protective cover glass provided in a far-infrared sensor SR.

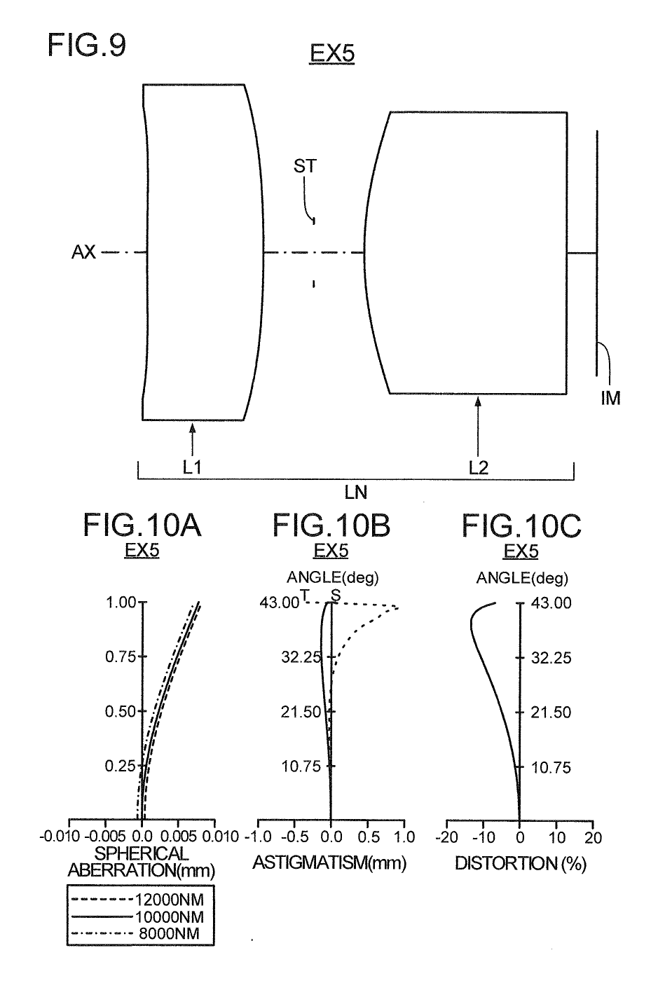

In Example 5 (EX5), the far-infrared lens system LN (FIG. 9) is composed of, from the object side, a first lens element L1 having a positive optical power, an aperture stop ST, and a second lens element L2 having a positive optical power. Considered in terms of paraxial surface shapes, the first lens element L1 is a biconvex positive lens element, and the second lens element L2 is a plano-convex positive lens element whose convex surface points to the object side. Both surfaces of the first lens element L1 and the object-side surface of the second lens element L2 are aspherical surfaces. The second lens element L2 constituting the fourth and fifth surfaces is integrated with a cover glass for a far-infrared sensor SR.

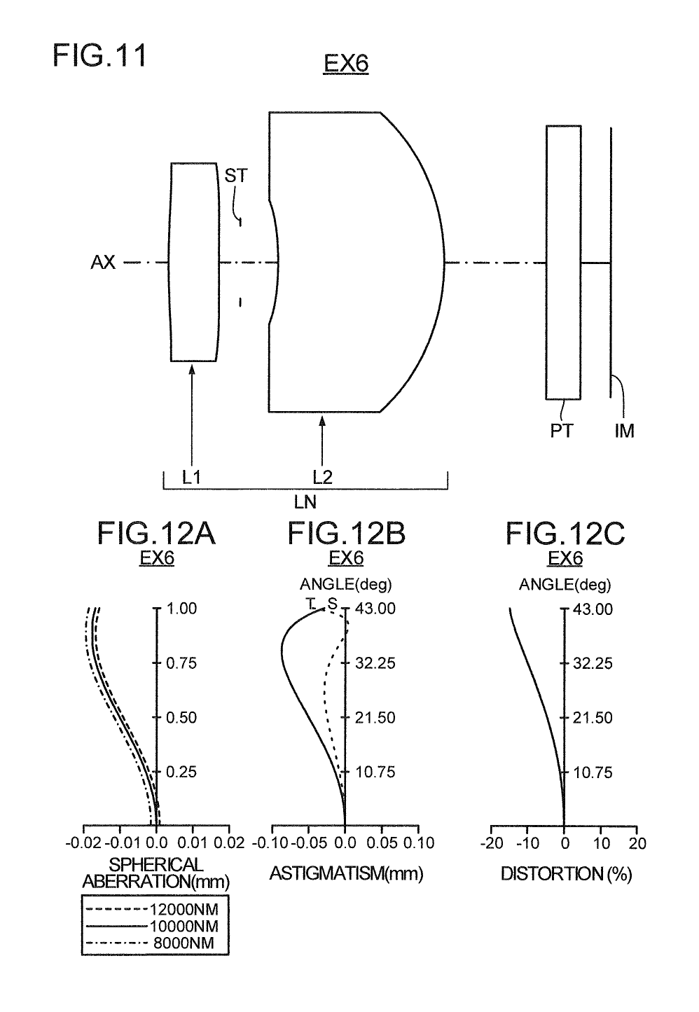

In Example 6 (EX6), the far-infrared lens system LN (FIG. 11) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a positive meniscus lens element convex to the image side. Both surfaces of the first lens element L1 and both surfaces of the second lens element L2 are aspherical surfaces. The plane-parallel plate PT constituting the sixth and seventh surfaces is a protective cover glass provided in a far-infrared sensor SR.

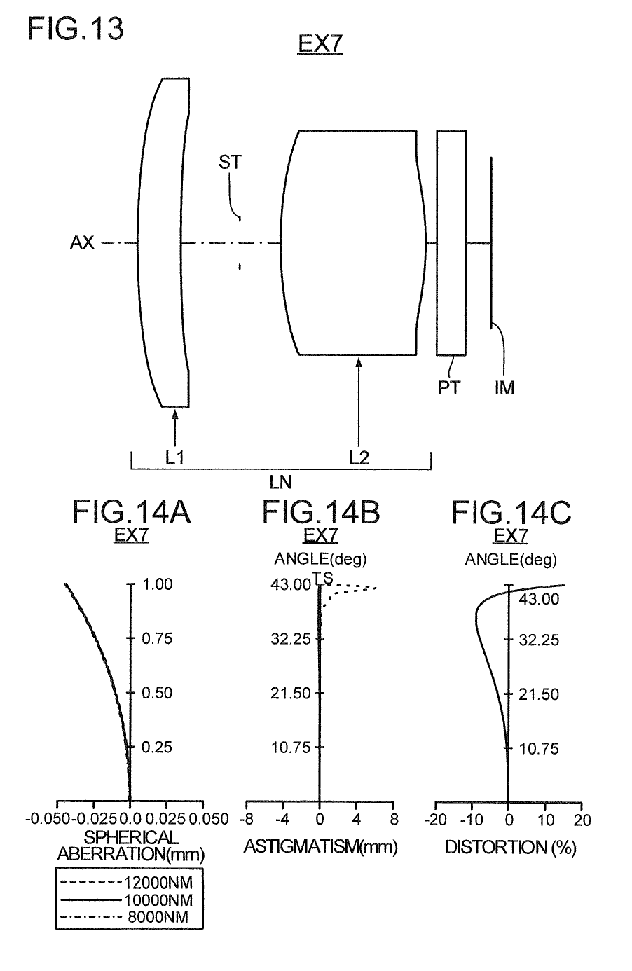

In Example 7 (EX7), the far-infrared lens system LN (FIG. 13) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a biconvex positive lens element. Both surfaces of the first lens element L1 and both surfaces of the second lens element L2 are aspherical surfaces. The plane-parallel plate PT constituting the sixth and seventh surfaces is a protective cover glass provided in a far-infrared sensor SR.

In Example 8 (EX8), the far-infrared lens system LN (FIG. 15) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a positive meniscus lens element convex to the image side. The plane-parallel plate PT constituting the sixth and seventh surfaces is a protective cover glass provided in a far-infrared sensor SR.

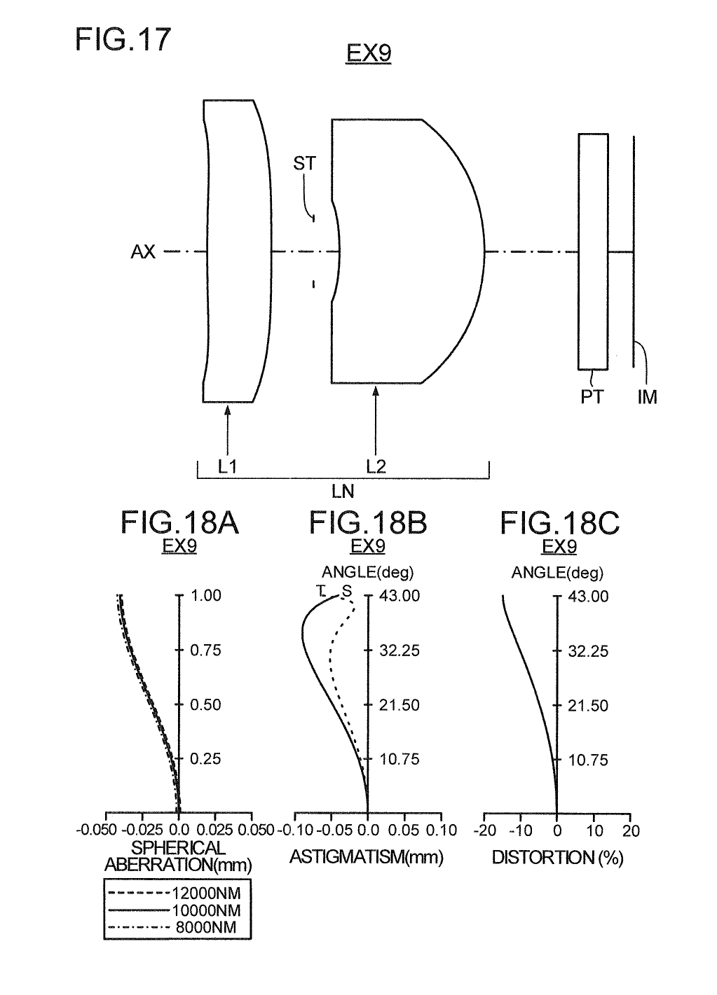

In Example 9 (EX9), the far-infrared lens system LN (FIG. 17) is composed of, from the object side, a first lens element L1 having a positive optical power, an aperture stop ST, and a second lens element L2 having a positive optical power. Considered in terms of paraxial surface shapes, the first lens element L1 is a biconvex positive lens element, and the second lens element L2 is a positive meniscus lens element convex to the image side. Both surfaces of the first lens element L1 and both surfaces of the second lens element L2 are aspherical surfaces. The plane-parallel plate PT constituting the sixth and seventh surfaces is a protective cover glass provided in a far-infrared sensor SR.

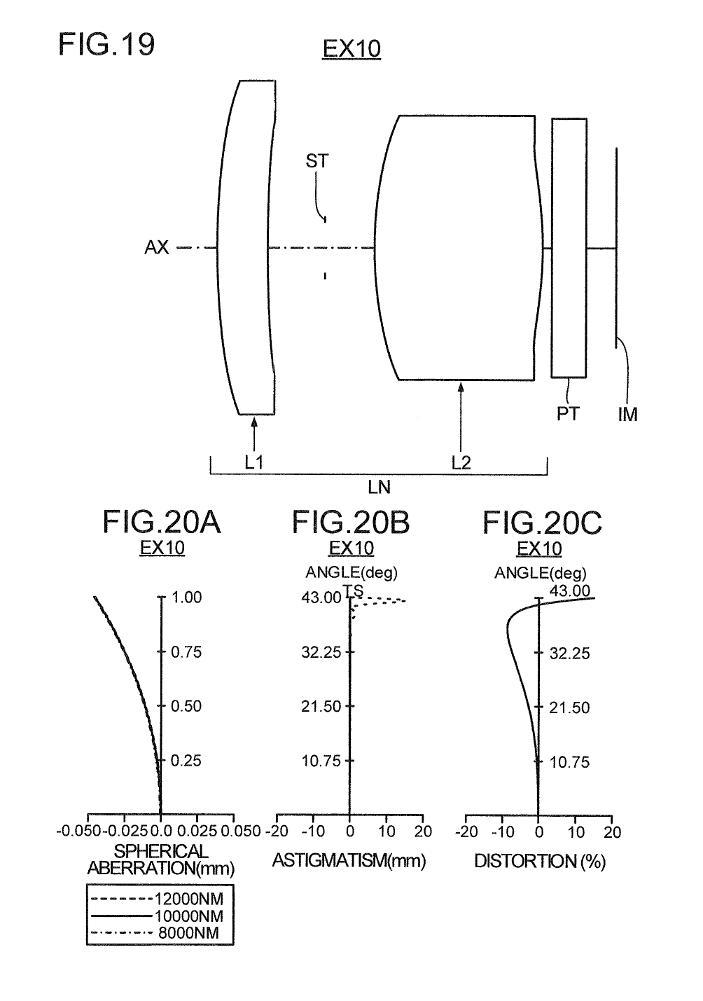

In Example 10 (EX10), the far-infrared lens system LN (FIG. 19) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the object side, and the second lens element L2 is a biconvex positive lens element. Both surfaces of the first lens element L1 and both surfaces of the second lens element L2 are aspherical surfaces. The plane-parallel plate PT constituting the sixth and seventh surfaces is a protective cover glass provided in a far-infrared sensor SR.

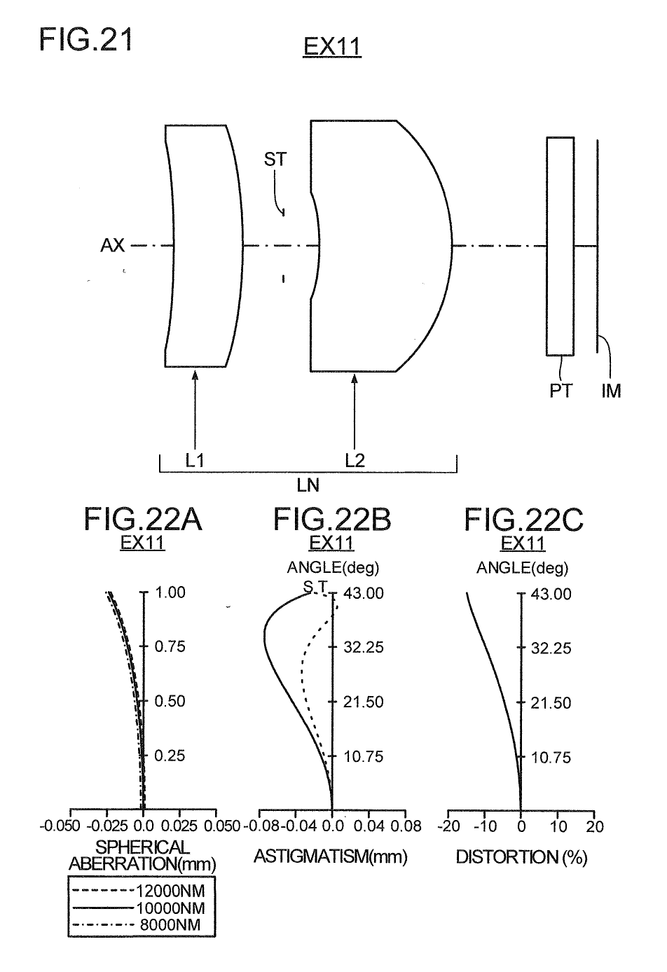

In Example 11 (EX11), the far-infrared lens system LN (FIG. 21) is composed of, from the object side, a first lens element L1 having a positive optical power, an aperture stop ST, and a second lens element L2 having a positive optical power. Considered in terms of paraxial surface shapes, the first lens element L1 is a positive meniscus lens element convex to the image side, and the second lens element L2 is a positive meniscus lens element convex to the image side. Both surfaces of the first lens element L1 and both surfaces of the second lens element L2 are aspherical surfaces. The plane-parallel plate PT constituting the sixth and seventh surfaces is a protective cover glass provided in a far-infrared sensor SR.

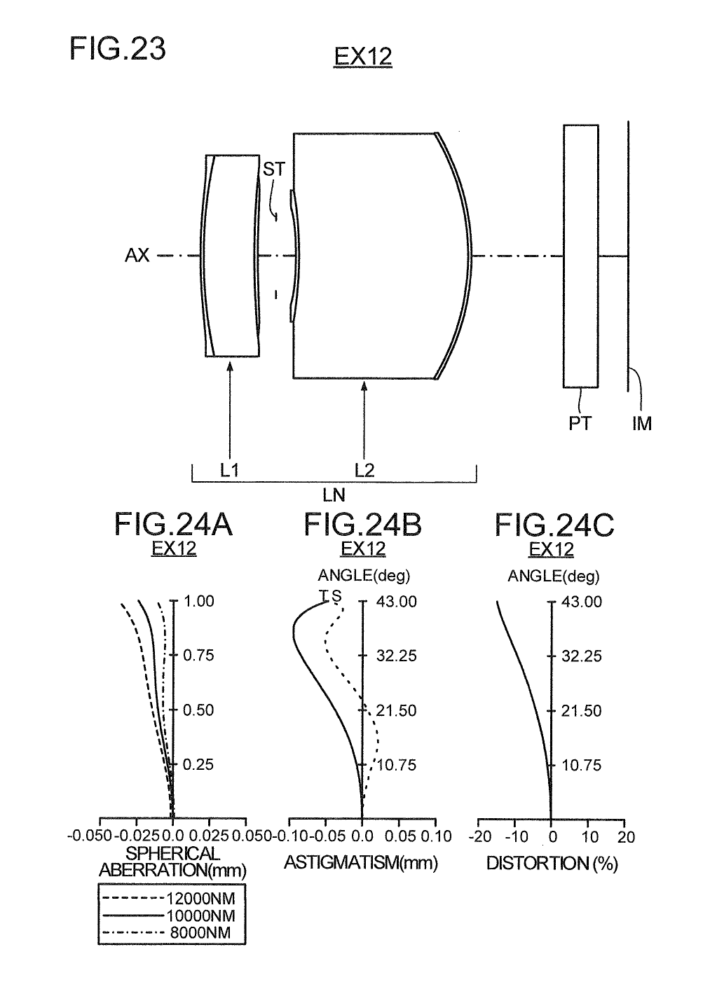

In Example 12 (EX12), the far-infrared lens system LN (FIG. 23) is composed of, from the object side, a first lens element L1 having a positive optical power and having coating layers on both surfaces thereof, an aperture stop ST, and a second lens element L2 having a positive optical power and having coating layers on both surfaces thereof. Considered in terms of paraxial surface shapes, the first lens element L1 is a positive meniscus lens element convex to the object side, and the second lens element L2 is a positive meniscus lens element convex to the image side. Both surfaces of the first lens element L1 and both surfaces of the second lens element L2 are aspherical surfaces. The plane-parallel plate PT constituting the tenth and eleventh surfaces is a protective cover glass provided in a far-infrared sensor SR.

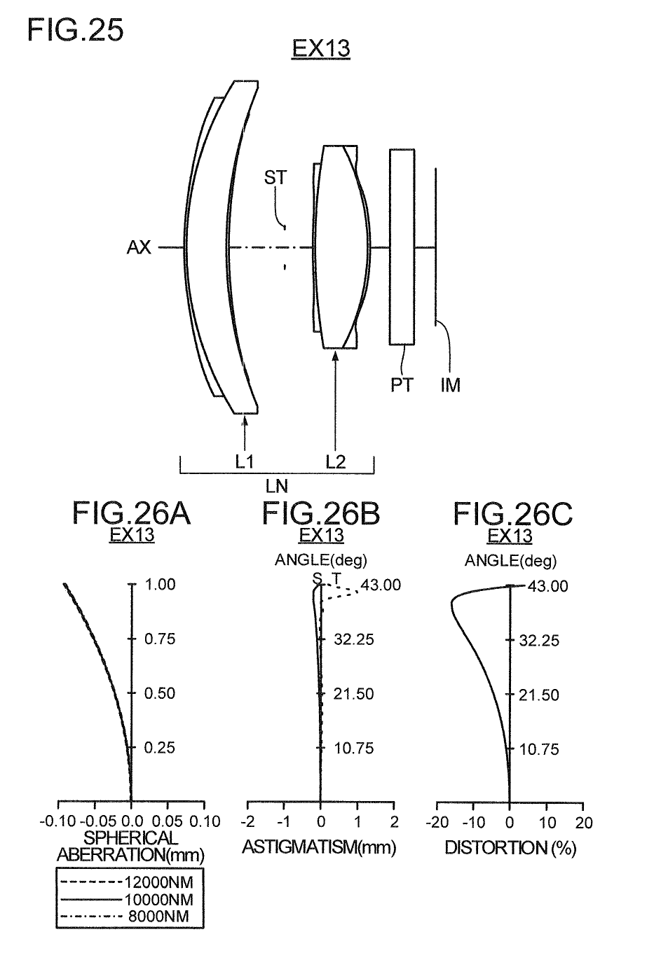

In Example 13 (EX13), the far-infrared lens system LN (FIG. 25) is composed of, from the object side, a first lens element L1 having a positive optical power and having coating layers on both surfaces thereof, an aperture stop ST, and a second lens element L2 having a positive optical power and having coating layers on both surfaces thereof. Considered in terms of paraxial surface shapes, the first lens element L1 is a positive meniscus lens element convex to the object side, and the second lens element L2 is a biconvex positive lens element. Both surfaces of the first lens element L1 and both surfaces of the second lens element L2 are aspherical surfaces. The plane-parallel plate PT constituting the tenth and eleventh surfaces is a protective cover glass provided in a far-infrared sensor SR.

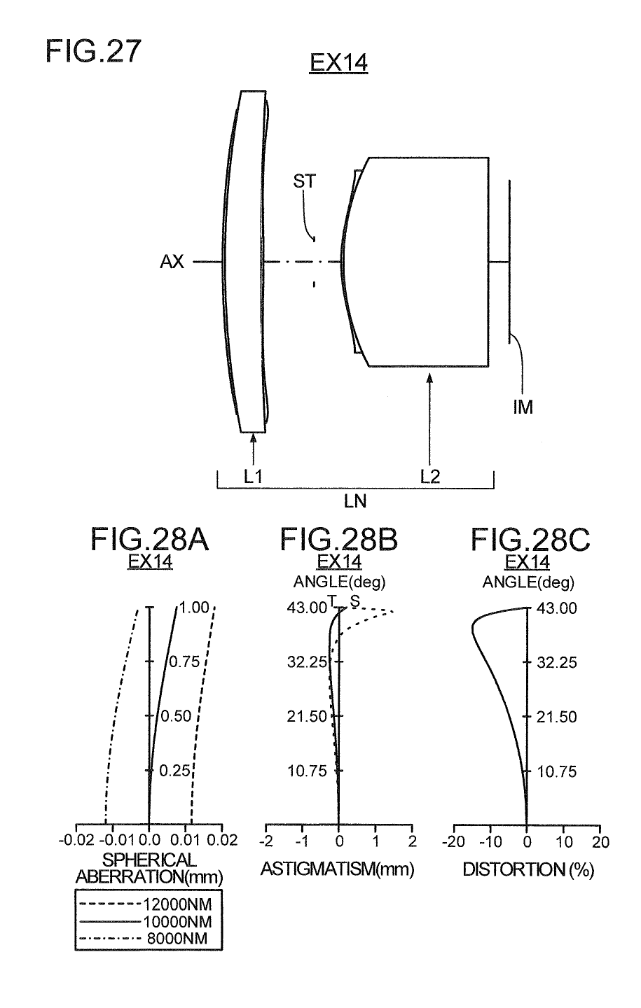

In Example 14 (EX14), the far-infrared lens system LN (FIG. 27) is composed of, from the object side, a first lens element L1 having a positive optical power and coating layers on both surfaces thereof, an aperture stop ST, and a second lens element L2 having a positive optical power and having a coating layer on the object-side surface. Considered in terms of paraxial surface shapes, the first lens element L1 is a biconvex positive lens element, and the second lens element L2 is a positive meniscus lens element convex to the object side. Both surfaces of the first lens element L1 and the object-side surface of the second lens element L2 are aspherical surfaces. The second lens element L2 constituting the sixth to eighth surfaces is integrated with a cover glass for a far-infrared sensor SR.

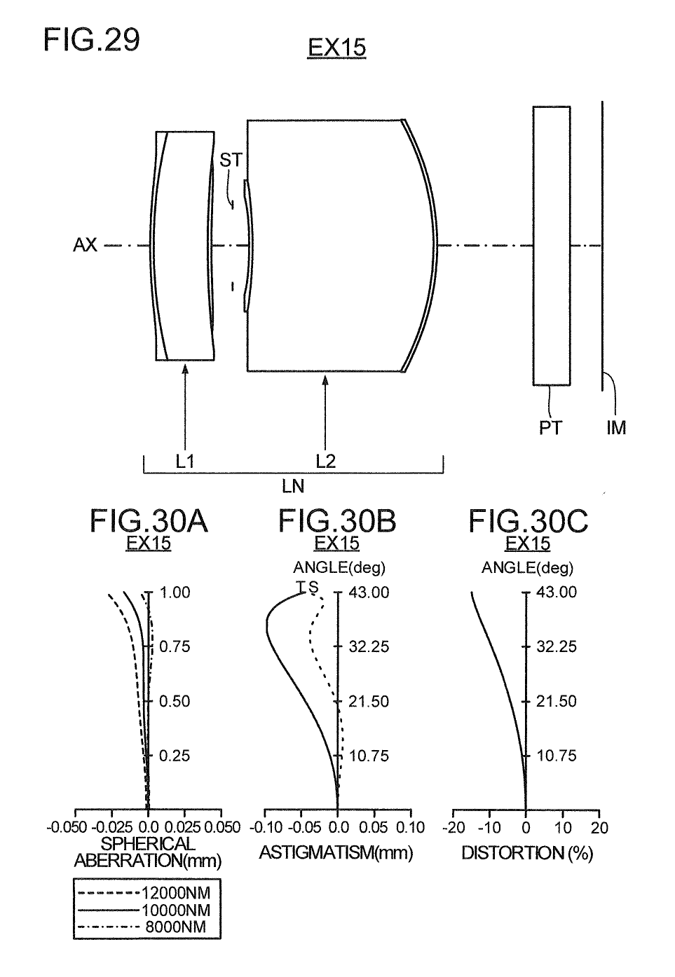

In Example 15 (EX15), the far-infrared lens system LN (FIG. 29) is composed of, from the object side, a first lens element L1 having a positive optical power and having coating layers on both surfaces thereof, an aperture stop ST, and a second lens element L2 having a positive optical power and having coating layers on both surfaces thereof. Considered in terms of paraxial surface shapes, the first lens element L1 is a positive meniscus lens element convex to the object side, and the second lens element L2 is a positive meniscus lens element convex to the image side. Both surfaces of the first lens element L1 and both surfaces of the second lens element L2 are aspherical surfaces. The plane-parallel plate PT constituting the tenth and eleventh surfaces is a protective cover glass provided in a far-infrared sensor SR.

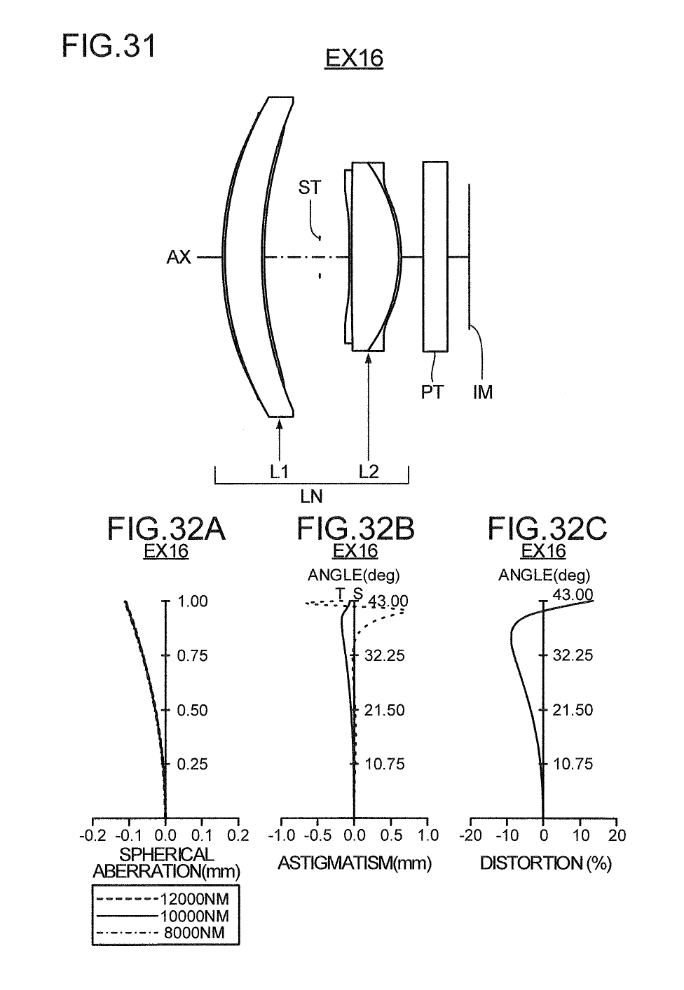

In Example 16 (EX16), the far-infrared lens system LN (FIG. 31) is composed of, from the object side, a first lens element L1 having a positive optical power and having coating layers on both surfaces thereof, an aperture stop ST, and a second lens element L2 having a positive optical power and having coating layers on both surfaces thereof. Considered in terms of paraxial surface shapes, the first lens element L1 is a positive meniscus lens element convex to the object side, and the second lens element L2 is a biconvex positive lens element. Both surfaces of the first lens element L1 and both surfaces of the second lens element L2 are aspherical surfaces. The plane-parallel plate PT constituting the tenth and eleventh surfaces is a protective cover glass provided in a far-infrared sensor SR.

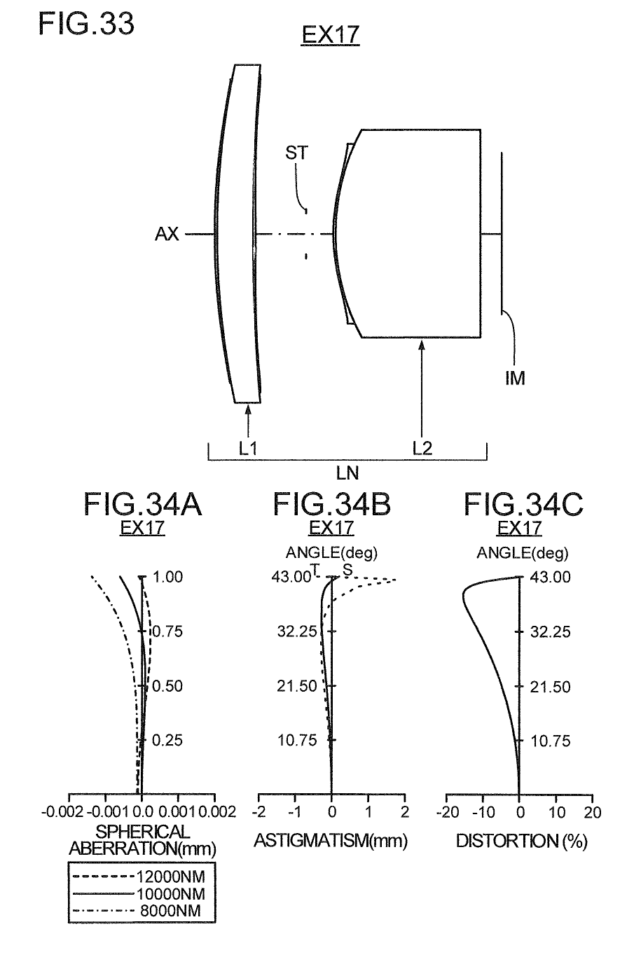

In Example 17 (EX17), the far-infrared lens system LN (FIG. 33) is composed of, from the object side, a first lens element L1 having a positive optical power and having coating layers on both surfaces thereof, an aperture stop ST, and a second lens element L2 having a positive optical power and having a coating layer on the object-side surface. Considered in terms of paraxial surface shapes, the first lens element L1 is a biconvex positive lens element, and the second lens element L2 is a plano-convex positive lens element whose convex surface points to the object side. Both surfaces of the first lens element L1 and the object-side surface of the second lens element L2 are aspherical surfaces. The second lens element L2 constituting the sixth to eighth surfaces is integrated with a cover glass for a far-infrared sensor SR.

### Example 1

Unit: mm
Surface Data

| i | r | d | N10 | ν |
|---|---|---|---|---|
| OB | INFINITY | INFINITY | | |
| 1 | 27.49962 | 2.389440 | 3.4178 | 1860 |
| 2 | 41.17168 | 3.929118 | | |
| 3(ST) | INFINITY | 0.178644 | | |
| 4 | −14.13077 | 5.000000 | 3.4178 | 1860 |
| 5 | −6.66742 | 2.500000 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.1270 |
| FNO | 1.8000 |
| TL | 14.9972 |
| ω | 43.0000° |

### Example 2

Unit: mm
Surface Data

| i | r | d | N10 | ν |
|---|---|---|---|---|
| OB | INFINITY | INFINITY | | |
| 1 | 15.19286 | 1.500000 | 3.4178 | 1860 |
| 2 | 21.45350 | 2.112804 | | |
| 3(ST) | INFINITY | 1.000000 | | |
| 4* | 7.47915 | 0.100000 | 1.5226 | 15.10 |
| 5 | 10.15462 | 6.000000 | 3.4178 | 1860 |
| 6 | 1.0E15 | 0.900000 | | |
| IM | INFINITY | 0.000000 | | |

Miscellaneous Data

| | |
|---|---|
| λ0 | 10000.0 nm |
| f | 4.0287 |
| FNO | 1.8000 |
| TL | 10.7128 |
| ω | 43.0000° |

Aspherical Surface Data
Aspherical Surface: i = 4*

| | |
|---|---|
| K = | 0.000000 |
| A4 = | −0.192121E−02 |
| A6 = | 0.000000E+00 |
| A8 = | 0.000000E+00 |
| A10 = | 0.000000E+00 |

### Example 3

Unit: mm
Surface Data

| i | r | d | N10 | ν |
|---|---|---|---|---|
| OB | INFINITY | INFINITY | | |
| 1 | 13.11422 | 1.500000 | 3.4178 | 1860 |
| 2 | 16.49414 | 2.006408 | | |
| 3(ST) | INFINITY | 1.043581 | | |
| 4 | −72.07863 | 2.590280 | 3.4178 | 1860 |
| 5 | −8.85877 | 1.795882 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.3769 |
| FNO | 1.8000 |
| TL | 9.9362 |
| ω | 43.0000° |

### Example 4

Unit: mm
Surface Data

| i | r | d | N10 | ν |
|---|---|---|---|---|
| OB | INFINITY | INFINITY | | |
| 1 | 25.38763 | 2.176300 | 3.4178 | 1860 |
| 2 | 38.15760 | 3.547059 | | |
| 3(ST) | INFINITY | 0.188329 | | |
| 4 | −14.22854 | 5.000000 | 3.4178 | 1860 |
| 5 | −6.73748 | 2.500000 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.1471 |
| FNO | 1.8000 |
| TL | 14.4117 |
| ω | 43.0000° |

### Example 5

Unit: mm
Surface Data

| i | r | d | N10 | ν |
|---|---|---|---|---|
| OB | INFINITY | INFINITY | | |
| 1* | 77.48277 | 3.457975 | 3.4178 | 1860 |
| 2* | −38.26964 | 1.500000 | | |
| 3(ST) | INFINITY | 1.490901 | | |
| 4* | 10.20600 | 6.000000 | 3.4178 | 1860 |
| 5 | INFINITY | 0.900000 | | |
| IM | INFINITY | 0.000000 | | |

Miscellaneous Data

| | |
|---|---|
| λ0 | 10000.0 nm |
| f | 3.9010 |
| FNO | 1.8000 |
| TL | 12.4489 |
| ω | 43.0000° |

Aspherical Surface Data
Aspherical Surface: i = 1*

| | |
|---|---|
| K = | 12.752963 |
| A4 = | −0.682344E−03 |
| A6 = | 0.000000E+00 |
| A8 = | 0.000000E+00 |
| A10 = | 0.000000E+00 |

Aspherical Surface: i = 2*

| | |
|---|---|
| K = | 41.419433 |
| A4 = | −0.441651E−03 |
| A6 = | 0.755177E−05 |
| A8 = | 0.000000E+00 |
| A10 = | 0.000000E+00 |

Aspherical Surface: i = 4*

| | |
|---|---|
| K = | −1.527898 |
| A4 = | −0.254883E−03 |
| A6 = | 0.000000E+00 |
| A8 = | 0.000000E+00 |
| A10 = | 0.000000E+00 |

### Example 6

Unit: mm
Surface Data

| i | r | d | N10 | ν |
|---|---|---|---|---|
| OB | INFINITY | INFINITY | | |
| 1* | 23.79133 | 1.500000 | 3.4178 | 1860 |
| 2* | 140.25331 | 0.632176 | | |
| 3(ST) | INFINITY | 1.129165 | | |
| 4* | −8.95626 | 4.918622 | 3.4178 | 1860 |
| 5* | −6.59171 | 3.047744 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.2924 |
| FNO | 1.8000 |
| TL | 12.2277 |
| ω | 43.0000° |

Aspherical Surface Data
Aspherical Surface: i = 1*

| | |
|---|---|
| K = | −50.000000 |
| A4 = | −0.641911E−03 |
| A6 = | −0.575438E−04 |
| A8 = | 0.000000E+00 |
| A10 = | 0.000000E+00 |

Aspherical Surface: i = 2*

| | |
|---|---|
| K = | 50.000000 |
| A4 = | −0.148514E−02 |
| A6 = | −0.155208E−04 |
| A8 = | 0.000000E+00 |
| A10 = | 0.000000E+00 |

Aspherical Surface: i = 4*

| | |
|---|---|
| K = | 6.372835 |
| A4 = | −0.340632E−02 |
| A6 = | −0.525122E−03 |
| A8 = | 0.000000E+00 |
| A10 = | 0.000000E+00 |

Aspherical Surface: i = 5*

| | |
|---|---|
| K = | −0.128600 |
| A4 = | −0.313785E−03 |
| A6 = | −0.914653E−05 |
| A8 = | 0.000000E+00 |
| A10 = | 0.000000E+00 |

### Example 7

Unit: mm
Surface Data

| i | r | d | N10 | ν |
|---|---|---|---|---|
| OB | INFINITY | INFINITY | | |
| 1* | 28.12955 | 1.500000 | 3.4178 | 1860 |
| 2* | 60.79737 | 2.038139 | | |
| 3(ST) | INFINITY | 1.421250 | | |
| 4* | 13.13338 | 5.000000 | 3.4178 | 1860 |
| 5* | −10.29980 | 0.389890 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 3.1761 |
| FNO | 1.8000 |
| TL | 11.3493 |
| ω | 43.0000° |

Aspherical Surface Data
Aspherical Surface: i = 1*

| | |
|---|---|
| K = | 4.570682 |
| A4 = | −0.529627E−04 |
| A6 = | 0.893239E−05 |
| A8 = | −0.448333E−08 |
| A10 = | 0.000000E+00 |

Aspherical Surface: i = 2*

| | |
|---|---|
| K = | 47.714661 |
| A4 = | 0.973790E−05 |
| A6 = | 0.122833E−04 |
| A8 = | 0.000000E+00 |
| A10 = | 0.000000E+00 |

Aspherical Surface: i = 4*

| | |
|---|---|
| K = | 8.835246 |
| A4 = | −0.822041E−03 |
| A6 = | 0.400491E−04 |
| A8 = | −0.258298E−05 |
| A10 = | 0.000000E+00 |

Aspherical Surface: i = 5*

| | |
|---|---|
| K = | −50.000000 |
| A4 = | −0.296185E−02 |
| A6 = | 0.246764E−03 |
| A8 = | 0.997977E−06 |
| A10 = | 0.000000E+00 |

### Example 8

Unit: mm
Surface Data

| i | r | d | N10 | ν |
|---|---|---|---|---|
| OB | INFINITY | INFINITY | | |
| 1 | 22.65998 | 2.006645 | 3.4178 | 1860 |
| 2 | 33.99470 | 3.086700 | | |
| 3(ST) | INFINITY | 0.187460 | | |
| 4 | −14.06617 | 5.000000 | 3.4178 | 1860 |
| 5 | −6.78391 | 2.500000 | | |
| 6 | INFINITY | 1.000000 | 3.4178 | 1860 |
| 7 | INFINITY | 0.900000 | | |
| IM | INFINITY | 0.000000 | | |
| Miscellaneous Data | | | | |
| λ0 | 10000.0 nm | | | |
| f | 4.1634 | | | |
| FNO | 1.8000 | | | |
| TL | 13.7808 | | | |
| ω | 43.0000° | | | |

### Example 9

Unit: mm
Surface Data

| i | r | d | N10 | ν |
|---|---|---|---|---|
| OB | INFINITY | INFINITY | | |
| 1 | 22.65998 | 2.006645 | 3.4178 | 1860 |
| 2 | 33.99470 | 3.086700 | | |
| 3(ST) | INFINITY | 0.187460 | | |
| 4 | −14.06617 | 5.000000 | 3.4178 | 1860 |
| 5 | −6.78391 | 2.500000 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.1634 |
| FNO | 1.8000 |
| TL | 13.7808 |
| ω | 43.0000° |

Aspherical Surface Data
Aspherical Surface: i = 1*

| | |
|---|---|
| K = | −50.000000 |
| A4 = | −0.490031E−03 |
| A6 = | −0.135950E−05 |
| A8 = | 0.000000E+00 |
| A10 = | 0.000000E+00 |

Aspherical Surface: i = 2*

| | |
|---|---|
| K = | −50.000000 |
| A4 = | 0.809774E−03 |
| A6 = | 0.200388E−05 |
| A8 = | 0.000000E+00 |
| A10 = | 0.000000E+00 |

Aspherical Surface: i = 4*

| | |
|---|---|
| K = | 11.565136 |
| A4 = | −0.253542E−02 |
| A6 = | −0.599919E−04 |
| A8 = | 0.000000E+05 |
| A10 = | 0.000000E+00 |

Aspherical Surface: i = 5*

| | |
|---|---|
| K = | 0.208177 |
| A4 = | −0.158079E−03 |
| A6 = | −0.645216E−03 |
| A8 = | 0.000000E+00 |
| A10 = | 0.000000E+00 |

### Example 10

Unit: mm
Surface Data

| i | r | d | N10 | ν |
|---|---|---|---|---|
| OB | INFINITY | INFINITY | | |
| 1* | 24.39058 | 1.500000 | 3.4178 | 1860 |
| 2* | 50.47864 | 1.708722 | | |
| 3(ST) | INFINITY | 1.463890 | | |
| 4* | 11.95186 | 5.000000 | 3.4178 | 1860 |
| 5* | −11.29497 | 0.271594 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 3.1791 |
| FNO | 1.8000 |
| TL | 10.9442 |
| ω | 43.0000° |

Aspherical Surface Data
Aspherical Surface: i = 1*

| | |
|---|---|
| K = | 6.112421 |
| A4 = | −0.255356E−04 |
| A6 = | 0.852556E−05 |
| A8 = | 0.271040E−08 |
| A10 = | 0.000000E+00 |

Aspherical Surface: i = 2*

| | |
|---|---|
| K = | 50.000000 |
| A4 = | 0.859158E−04 |
| A6 = | 0.116900E−04 |
| A8 = | 0.000000E+00 |
| A10 = | 0.000000E+00 |

Aspherical Surface: i = 4*

| | |
|---|---|
| K = | 5.630439 |
| A4 = | −0.379398E−03 |
| A6 = | −0.168516E−04 |
| A8 = | 0.582155E−06 |
| A10 = | 0.000000E+00 |

Aspherical Surface: i = 5*

| | |
|---|---|
| K = | −50.000000 |
| A4 = | −0.147977E−02 |
| A6 = | 0.864720E−04 |
| A8 = | 0.889825E−05 |
| A10 = | 0.000000E+00 |

### Example 11

Unit: mm
Surface Data

| i | r | d | N10 | ν |
|---|---|---|---|---|
| OB | INFINITY | INFINITY | | |
| 1* | −33.26351 | 2.607340 | 3.4178 | 1860 |
| 2* | −18.95000 | 1.552262 | | |
| 3(ST) | INFINITY | 1.350176 | | |
| 4* | −9.20889 | 5.000000 | 3.4178 | 1860 |
| 5* | −6.76124 | 3.590222 | | |
| 6 | INFINITY | 1.000000 | 3.4178 | 1860 |
| 7 | INFINITY | 0.900000 | | |
| IM | INFINITY | 0.000000 | | |

Miscellaneous Data

| | |
|---|---|
| λ0 | 10000.0 nm |
| f | 4.2912 |
| FNO | 1.8000 |
| TL | 15.1000 |
| ω | 43.0000° |

Aspherical Surface Data
Aspherical Surface: i = 1*

| | |
|---|---|
| K = | −50.000000 |
| A4 = | −0.216985E−03 |
| A6 = | −0.154562E−04 |
| A8 = | 0.000000E+00 |
| A10 = | 0.000000E+00 |

Aspherical Surface: i = 2*

| | |
|---|---|
| K = | −50.000000 |
| A4 = | −0.634781E−03 |
| A6 = | 0.309010E−06 |
| A8 = | 0.000000E+00 |
| A10 = | 0.000000E+00 |

Aspherical Surface: i = 4*

| | |
|---|---|
| K = | 7.127641 |
| A4 = | −0.231988E−02 |
| A6 = | −0.342624E−03 |
| A8 = | 0.000000E+00 |
| A10 = | 0.000000E+00 |

Aspherical Surface: i = 5*

| | |
|---|---|
| K = | 0.073038 |
| A4 = | −0.152926E−03 |
| A6 = | −0.573821E−05 |
| A8 = | 0.000000E+00 |
| A10 = | 0.000000E+00 |

### Example 12

Unit: mm
Surface Data

| i | r | d | N10 | ν |
|---|---|---|---|---|
| OB | INFINITY | INFINITY | | |
| 1* | 14.22191 | 0.100000 | 1.5226 | 15.10 |
| 2 | 14.12191 | 1.500000 | 3.4178 | 1860 |
| 3 | 26.10156 | 0.100000 | 1.5226 | 15.10 |
| 4* | 26.00156 | 0.545922 | | |
| 5(ST) | INFINITY | 0.587787 | | |
| 6* | −11.63910 | 0.100000 | 1.5226 | 15.10 |
| 7 | −11.73910 | 5.000000 | 3.4178 | 1860 |
| 8 | −7.14015 | 0.100000 | 1.5226 | 15.10 |
| 9* | −7.24015 | 2.754097 | | |
| 10 | INFINITY | 1.000000 | 3.4178 | 1860 |
| 11 | INFINITY | 0.900000 | | |
| IM | INFINITY | 0.000000 | | |

Miscellaneous Data

| | |
|---|---|
| λ0 | 10000.0 nm |
| f | 4.2998 |
| FNO | 1.8000 |
| TL | 11.7878 |
| ω | 43.0000° |

Aspherical Surface Data
Aspherical Surface: i = 1*

| | |
|---|---|
| K = | −18.158430 |
| A4 = | −0.644862E−03 |
| A6 = | 0.266056E−04 |
| A8 = | 0.773686E−05 |
| A10 = | −0.294774E−05 |

Aspherical Surface: i = 4*

| | |
|---|---|
| K = | −50.000000 |
| A4 = | −0.126239E−02 |
| A6 = | 0.544942E−03 |
| A8 = | −0.193078E−03 |
| A10 = | 0.943235E−05 |

Aspherical Surface: i = 6*

| | |
|---|---|
| K = | 15.581953 |
| A4 = | −0.827233E−02 |
| A6 = | −0.405632E−02 |
| A8 = | 0.204924E−02 |
| A10 = | −0.376907E−03 |

Aspherical Surface: i = 9*

| | |
|---|---|
| K = | −12.328512 |
| A4 = | −0.324527E−02 |
| A6 = | −0.480705E−06 |
| A8 = | 0.154860E−04 |
| A10 = | −0.654897E−06 |

### Example 13

Unit: mm
Surface Data

| i | r | d | N10 | ν |
|---|---|---|---|---|
| OB | INFINITY | INFINITY | | |
| 1* | 13.15744 | 0.100000 | 1.5226 | 15.10 |
| 2 | 13.05744 | 1.651328 | 3.4178 | 1860 |
| 3 | 17.47125 | 0.100000 | 1.5226 | 15.10 |
| 4* | 17.37125 | 2.332330 | | |
| 5(ST) | INFINITY | 1.162452 | | |
| 6* | 24.77130 | 0.100000 | 1.5226 | 15.10 |
| 7 | 24.67130 | 2.162416 | 3.4178 | 1860 |
| 8 | −9.25400 | 0.100000 | 1.5226 | 15.10 |
| 9* | −9.35400 | 0.819559 | | |
| 10 | INFINITY | 1.000000 | 3.4178 | 1860 |
| 11 | INFINITY | 0.900000 | | |
| IM | INFINITY | 0.000000 | | |

Miscellaneous Data

| | |
|---|---|
| λ0 | 10000.0 nm |
| f | 3.5048 |
| FNO | 1.8000 |
| TL | 9.5281 |
| ω | 43.0000° |

Aspherical Surface Data
Aspherical Surface: i = 1*

| | |
|---|---|
| K = | 1.223274 |
| A4 = | −0.923286E−03 |
| A6 = | 0.230194E−04 |
| A8 = | −0.139009E−06 |
| A10 = | −0.115818E−08 |

Aspherical Surface: i = 4*

| | |
|---|---|
| K = | 6.121884 |
| A4 = | −0.734652E−03 |
| A6 = | 0.201799E−04 |
| A8 = | 0.316692E−07 |
| A10 = | −0.855988E−08 |

Aspherical Surface: i = 6*

| | |
|---|---|
| K = | 50.000000 |
| A4 = | 0.234517E−02 |
| A6 = | −0.219853E−02 |
| A8 = | 0.286905E−03 |
| A10 = | −0.115304E−04 |

Aspherical Surface: i = 9*

| | |
|---|---|
| K = | 1.157313 |
| A4 = | 0.657767E−02 |
| A6 = | −0.244609E−02 |
| A8 = | 0.247673E−03 |
| A10 = | −0.698199E−05 |

### Example 14

Unit: mm
Surface Data

| i | r | d | N10 | ν |
|---|---|---|---|---|
| OB | INFINITY | INFINITY | | |
| 1* | 39.60693 | 0.100000 | 1.5226 | 15.10 |
| 2 | 37.84099 | 1.500000 | 3.4178 | 1860 |
| 3 | 132.96439 | 0.100000 | 1.5226 | 15.10 |
| 4* | −74.31562 | 2.114237 | | |
| 5(ST) | INFINITY | 1.123688 | | |
| 6* | 6.43904 | 0.100000 | 1.5226 | 15.10 |
| 7 | 9.49876 | 6.000000 | 3.4178 | 1860 |
| 8 | 1.0E15 | 0.900000 | | |
| IM | INFINITY | 0.000000 | | |

Miscellaneous Data

| | |
|---|---|
| λ0 | 10000.0 nm |
| f | 3.6325 |
| FNO | 1.8000 |
| TL | 11.0379 |
| ω | 43.0000° |

Aspherical Surface Data
Aspherical Surface: i = 1*

| | |
|---|---|
| K = | 16.143505 |
| A4 = | 0.204064E−03 |
| A6 = | −0.223411E−04 |
| A8 = | 0.807985E−06 |
| A10 = | −0.930981E−08 |

Aspherical Surface: i = 4*

| | |
|---|---|
| K = | −48.697510 |
| A4 = | 0.670615E−03 |
| A6 = | −0.289117E−04 |
| A8 = | 0.100785E−05 |
| A10 = | −0.133182E−07 |

Aspherical Surface: i = 6*

| | |
|---|---|
| K = | 0.000000 |
| A4 = | −0.353136E−02 |
| A6 = | 0.317065E−04 |
| A8 = | 0.000000E+00 |
| A10 = | 0.000000E+00 |

### Example 15

Unit: mm
Surface Data

| i | r | d | N10 | ν |
|---|---|---|---|---|
| OB | INFINITY | INFINITY | | |
| 1* | 13.34570 | 0.100000 | 1.6700 | 22.33 |
| 2 | 13.24570 | 1.500000 | 3.4178 | 1860 |
| 3 | 24.67262 | 0.100000 | 1.6700 | 22.33 |
| 4* | 24.57262 | 0.584695 | | |
| 5(ST) | INFINITY | 0.459801 | | |
| 6* | −11.71626 | 0.100000 | 1.5226 | 15.10 |
| 7 | −11.81626 | 5.000000 | 3.4178 | 1860 |
| 8 | −7.20363 | 0.100000 | 1.5226 | 15.10 |
| 9* | −7.30363 | 2.675682 | | |
| 10 | INFINITY | 1.000000 | 3.4178 | 1860 |
| 11 | INFINITY | 0.900000 | | |
| IM | INFINITY | 0.000000 | | |

Miscellaneous Data

| | |
|---|---|
| λ0 | 10000.0 nm |
| f | 4.3011 |
| FNO | 1.8000 |
| TL | 11.6202 |
| ω | 43.0000° |

Aspherical Surface Data
Aspherical Surface: i = 1*

| | |
|---|---|
| K = | −20.544412 |
| A4 = | −0.563745E−03 |
| A6 = | 0.140882E−04 |
| A8 = | −0.937490E−05 |
| A10 = | −0.637631E−06 |

Aspherical Surface: i = 4*

| | |
|---|---|
| K = | −9.650146 |
| A4 = | −0.181841E−02 |
| A6 = | 0.157839E−03 |
| A8 = | −0.932152E−04 |
| A10 = | 0.613617E−05 |

Aspherical Surface: i = 6*

| | |
|---|---|
| K = | 17.618795 |
| A4 = | −0.956305E−02 |
| A6 = | −0.330015E−02 |
| A8 = | 0.201726E−02 |
| A10 = | −0.429521E−03 |

Aspherical Surface: i = 9*

| | |
|---|---|
| K = | −11.726827 |
| A4 = | −0.327076E−02 |
| A6 = | 0.186078E−04 |
| A8 = | 0.151055E−04 |
| A10 = | −0.655504E−06 |

### Example 16

Unit: mm
Surface Data

| i | r | d | N10 | ν |
|---|---|---|---|---|
| OB | INFINITY | INFINITY | | |
| 1* | 13.15744 | 0.100000 | 1.5226 | 15.10 |
| 2 | 13.05744 | 1.530806 | 3.4178 | 1860 |
| 3 | 16.39283 | 0.100000 | 1.5226 | 15.10 |
| 4* | 16.29283 | 2.322649 | | |
| 5(ST) | INFINITY | 1.216746 | | |
| 6* | 178.79265 | 0.100000 | 1.6700 | 22.33 |
| 7 | 178.69265 | 1.944737 | 3.4178 | 1860 |
| 8 | −6.64235 | 0.100000 | 1.6700 | 22.33 |
| 9* | −6.74235 | 0.917302 | | |
| 10 | INFINITY | 1.000000 | 3.4178 | 1860 |
| 11 | INFINITY | 0.900000 | | |
| IM | INFINITY | 0.000000 | | |

Miscellaneous Data

| | |
|---|---|
| λ0 | 10000.0 nm |
| f | 3.2179 |
| FNO | 1.8000 |
| TL | 9.3322 |
| ω | 43.0000° |

Aspherical Surface Data
Aspherical Surface: i = 1*

| | |
|---|---|
| K = | 0.630947 |
| A4 = | −0.923430E−04 |
| A6 = | 0.127395E−04 |
| A8 = | −0.147111E−06 |
| A10 = | −0.376346E−08 |

Aspherical Surface: i = 4*

| | |
|---|---|
| K = | 5.215548 |
| A4 = | −0.174525E−03 |
| A6 = | 0.689998E−05 |
| A8 = | −0.421758E−06 |
| A10 = | −0.106114E−08 |

Aspherical Surface: i = 6*

| | |
|---|---|
| K = | 50.000000 |
| A4 = | −0.103688E−02 |
| A6 = | −0.260659E−02 |
| A8 = | 0.502069E−03 |
| A10 = | −0.259026E−04 |

Aspherical Surface: i = 9*

| | |
|---|---|
| K = | −0.022005 |
| A4 = | 0.387988E−02 |
| A6 = | −0.206699E−02 |
| A8 = | 0.270460E−03 |
| A10 = | −0.946983E−05 |

### Example 17

Unit: mm
Surface Data

| i | r | d | N10 | ν |
|---|---|---|---|---|
| OB | INFINITY | INFINITY | | |
| 1* | 34.89934 | 0.100000 | 1.5226 | 15.10 |
| 2 | 33.69657 | 1.500000 | 3.4178 | 1860 |
| 3 | 82.42368 | 0.100000 | 1.5226 | 15.10 |
| 4* | −120.08738 | 2.114237 | | |
| 5(ST) | INFINITY | 1.123688 | | |
| 6* | 6.98192 | 0.100000 | 1.6700 | 22.33 |
| 7 | 9.23780 | 6.000000 | 3.4178 | 1860 |
| 8 | INFINITY | 0.900000 | | |
| IM | INFINITY | 0.000000 | | |

Miscellaneous Data

| | |
|---|---|
| λ0 | 1000.0 nm |
| f | 3.6014 |
| FNO | 1.8000 |
| TL | 11.0379 |
| ω | 43.0000° |

Aspherical Surface Data
Aspherical Surface: i = 1*

| | |
|---|---|
| K = | −16.455627 |
| A4 = | 0.538322E−03 |
| A6 = | −0.297063E−04 |
| A8 = | 0.715168E−06 |
| A10 = | −0.635510E−08 |

Aspherical Surface: i = 4*

| | |
|---|---|
| K = | 50.000000 |
| A4 = | 0.758016E−03 |
| A6 = | −0.335280E−04 |
| A8 = | 0.850851E−06 |
| A10 = | −0.856451E−08 |

Aspherical Surface: i = 6*

| | |
|---|---|
| K = | 0.000000 |
| A4 = | −0.253484E−02 |
| A6 = | 0.809611E−05 |
| A8 = | 0.000000E+00 |
| A10 = | 0.000000E+00 |

TABLE 1

| | Conditional | Conditional | Conditional | Conditional | Conditional |
|---|---|---|---|---|---|
| | Formula (1) | Formula (2) | Formula (3) | Formula (4) | Formula (5) |
| | | | (R1 + R2)/(R1 − | | |
| Example | f1/f | f2/f1 | R2) | D1/f | LB/f |
| 1 | 7.3860 | 0.1162 | −5.0227 | 0.5790 | 0.8947 |
| 2 | 4.5702 | 0.2124 | −5.8535 | 0.3723 | 0.2234 |
| 3 | 4.6026 | 0.2015 | −8.7601 | 0.3427 | 0.6828 |
| 4 | 6.7517 | 0.1284 | −4.9761 | 0.5248 | 0.8904 |
| 5 | 2.7746 | 0.3900 | 0.3388 | 0.8864 | 0.2307 |
| 6 | 2.7358 | 0.3558 | −1.4086 | 0.3495 | 0.9879 |
| 7 | 6.6028 | 0.1341 | −2.7222 | 0.4723 | 0.4982 |
| 8 | 6.0000 | 0.1460 | −4.9983 | 0.4820 | 0.8869 |
| 9 | 3.5000 | 0.2638 | −0.6499 | 0.5174 | 1.0379 |
| 10 | 5.8999 | 0.1510 | −2.8699 | 0.4718 | 0.4606 |
| 11 | 3.7600 | 0.2667 | 3.6478 | 0.6076 | 1.1146 |
| 12 | 2.7290 | 0.3653 | −3.4147 | 0.3954 | 0.9179 |
| 13 | 4.8519 | 0.1725 | −7.2449 | 0.5282 | 0.5741 |
| 14 | 4.8987 | 0.2010 | −0.3047 | 0.4680 | 0.2478 |
| 15 | 2.5281 | 0.3997 | −3.3774 | 0.3952 | 0.8994 |
| 16 | 6.2715 | 0.1334 | −9.3928 | 0.5379 | 0.6557 |
| 17 | 5.2285 | 0.1869 | −0.5496 | 0.4720 | 0.2499 |
| Example | f1 | f2 | D1 | LB | |
| 1 | 30.4822 | 3.5424 | 2.389 | 3.693 | |
| 2 | 18.4120 | 3.9116 | 1.500 | 0.900 | |
| 3 | 20.1450 | 4.0597 | 1.500 | 2.988 | |
| 4 | 28.0000 | 3.5953 | 2.176 | 3.693 | |
| 5 | 10.8239 | 4.2212 | 3.458 | 0.900 | |
| 6 | 11.7432 | 4.1782 | 1.500 | 4.240 | |
| 7 | 20.9713 | 2.8120 | 1.500 | 1.582 | |
| 8 | 24.9802 | 3.6478 | 2.007 | 3.693 | |
| 9 | 15.0266 | 3.9633 | 2.222 | 4.456 | |
| 10 | 18.7565 | 2.8328 | 1.500 | 1.464 | |
| 11 | 16.1350 | 4.3030 | 2.607 | 4.783 | |
| 12 | 11.7343 | 4.2869 | 1.700 | 3.947 | |
| 13 | 17.0051 | 2.9332 | 1.851 | 2.012 | |
| 14 | 17.7945 | 3.5763 | 1.700 | 0.900 | |
| 15 | 10.8737 | 4.3459 | 1.700 | 3.868 | |
| 16 | 20.1812 | 2.6916 | 1.731 | 2.110 | |
| 17 | 18.8298 | 3.5202 | 1.700 | 0.900 | |

### LIST OF REFERENCE SIGNS

DU digital appliance (camera system)
LU imaging optical device
LN far-infrared lens system
L1 first lens element
L2 second lens element
ST aperture stop (stop)
SR far-infrared sensor (imaging device)
SS light-receiving surface (imaging surface)
IM image surface (optical image)
AX optical axis
1 signal processor
2 controller
3 memory
4 operation panel
5 display

1. A far-infrared lens system for use in a far-infrared region, comprising two lens elements, which are, from an object side,
a first lens element having a positive optical power; and
a second lens element having a positive optical power, wherein
a refractive index of a lens material that constitutes a largest central thickness in each lens element is, at a wavelength of 10 μm, higher than 2.0 but equal to or lower than 3.9,
conditional formula (1) below is fulfilled, and
a half-angle of view is larger than 30°
2.50<f1/f<7.40 (1)
where
f1 represents a focal length of the first lens element; and
f represents a focal length of the entire far-infrared lens system.

2. The far-infrared lens system of claim 1, wherein
when dispersions v at wavelengths from 8 to 12 μm are defined by formula (FD) below, a dispersion v of the lens material that constitutes the largest central thickness in each of the first and second lens elements is higher than 100
v=(N10−1)/(N8−N12) (FD)
where
N10 represents a refractive index at a wavelength of 10 μm;
N8 represents a refractive index at a wavelength of 8 μm; and
N12 represents a refractive index at a wavelength of 12 μm.

3. The far-infrared lens system of claim 1, wherein
conditional formula (2) below is fulfilled:
0.11<f2/f1<0.60 (2)
where
f1 represents the focal length of the first lens element; and
f2 represents a focal length of the second lens element.

4. The far-infrared lens system of claim 1, wherein
conditional formula (3) below is fulfilled:
−9.40<(R1+R2)/(R1−R2)<3.65 (3)
where
R1 represents a radius of curvature of a most object-side surface of the first lens element; and
R2 represents a radius of curvature of a most image-side surface of the first lens element.

5. The far-infrared lens system of claim 1, wherein
conditional formula (4) below is fulfilled:
0.34<D1/f<0.89 (4)
where
D1 represents a total on-axis central thickness from a most object-side surface to a most image-side surface of the first lens element; and
f represents the focal length of the entire far-infrared lens system.

6. The far-infrared lens system of claim 1, wherein
conditional formula (5) below is fulfilled:
0.2<LB/f<1.1 (5)
where
LB represents an air-equivalent length of a distance from a most image-side surface of the second lens element to an image surface; and
f represents the focal length of the entire far-infrared lens system.

7. An imaging optical device comprising:
the far-infrared lens system of claim 1; and
a far-infrared sensor which converts a far-infrared optical image formed on an imaging surface thereof into an electrical signal, wherein
the far-infrared lens system is arranged such that a far-infrared optical image of a subject is formed on the imaging surface of the far-infrared sensor.

8. A digital appliance comprising the imaging optical device of claim 7 so as to be additionally provided with at least one of functions of taking a still image of a subject and taking a moving image of a subject.

9. A far-infrared camera system comprising the far-infrared lens system of claim 1.
